(19) United States
(12) Patent Application Publication
(10) Pub. No.: US 2026/0172797 A1
(43) Pub. Date: Jun. 18, 2026

(54) ARTIFICIAL INTELLIGENCE SYSTEM FOR INTERNET OF WORKERS PLATFORM

(71) Applicant: Weavix, Inc., Wichita, KS (US)

(72) Inventors: Kevin TURPIN, Wichita, KS (US); Benjamin BURRUS, Wichita, KS (US)

(21) Appl. No.: 19/407,438

(22) Filed: Dec. 3, 2025

Related U.S. Application Data
(60) Provisional application No. 63/733,043, filed on Dec. 12, 2024.

(51) Int. Cl. H04W 4/70; G06N 3/0475; G10L 13/02; G10L 15/22; H04W 4/10

(52) U.S. Cl. CPC H04W 4/70; G06N 3/0475; G10L 13/02; G10L 15/22; H04W 4/10; G10L 2015/223

(57) ABSTRACT

The disclosed technology facilitates communication between frontline workers and industrial systems using portable devices and generative artificial intelligence models (“GAI Models”). Workers use smart radios to issue natural language commands, which GAI Models interpret to generate machine-specific actions. These models process inputs such as spoken language, text, and gestures, making the system adaptable to various environments. The models can be trained on machine data and worker interactions for improved accuracy. Additionally, the system uses location and user information to customize responses and can handle machine-generated alerts for worker intervention.

### CROSS-REFERENCE TO RELATED APPLICATIONS

This application claims the benefit of U.S. Provisional Patent Application Ser. No. 63/733,043, filed Dec. 12, 2024, which is incorporated by reference herein in its entirety.

### TECHNICAL FIELD

The present disclosure is generally related to wireless communication handsets and systems.

### BACKGROUND

Frontline workers often rely on radios to enable them to communicate with their team members. Traditional radios may fail to provide some communication services, requiring workers to carry additional devices to stay adequately connected to their team. Often, these devices are unfit for in-field use due to their fragile design or their lack of usability during frontline work. For example, smartphones, laptops, or tablets with additional communication capabilities may be easily damaged in the field, difficult to use in a dirty environment or when wearing protective equipment, or overly bulky for daily transportation on site. Accordingly, workers may be less accessible to their teams, which can lead to safety concerns and a decrease in productivity.

### BRIEF DESCRIPTION OF THE DRAWINGS

FIG. 1 is a block diagram illustrating an example architecture for an apparatus for device communication and tracking, in accordance with one or more embodiments.

FIG. 2 is a block diagram illustrating an example apparatus for device communication and tracking, in accordance with one or more embodiments.

FIG. 3 is a block diagram illustrating an example charging station for apparatuses implementing device communication and tracking, in accordance with one or more embodiments.

FIG. 4A is a block diagram illustrating an example environment for apparatuses and communication networks for device communication and tracking, in accordance with one or more embodiments.

FIG. 4B is a flow diagram illustrating an example process for generating a work experience profile, in accordance with one or more embodiments.

FIG. 5 is a block diagram illustrating an example facility using apparatuses and communication networks for device communication and tracking, in accordance with one or more embodiments.

FIG. 6 illustrates an example of a worksite that includes a plurality of geofenced areas, in accordance with one or more embodiments.

FIG. 7 is an illustration showing communication between frontline workers and industrial systems at a worksite through a portable user device and generative artificial intelligence models.

FIG. 8a is a flow diagram of processes performed by a system to exchange communications between frontline workers and machines at a worksite based on a user-generated prompt.

FIG. 8b is a flow diagram of processes performed by the system to exchange communications between frontline workers and machines at a worksite based on a machine-generated prompt.

FIG. 9 is a block diagram of a transformer neural network, which may be used in examples of the present disclosure.

FIG. 10 is a block diagram illustrating an example computer system, in accordance with one or more embodiments.

### DETAILED DESCRIPTION

The disclosed technology relates to an artificial intelligence (AI) system including one or more generative artificial intelligence models (“GAI Models”) configured to facilitate exchanging communications between frontline workers and industrial machines through a portable user device (e.g., a smart radio device, also referred to as a “smart radio”). The GAI Models are configured to interpret natural language prompts and commands input from a frontline worker to a smart radio device, which causes a machine at a worksite to perform an action or return machine-based data that is presented to the frontline worker in a natural language format. The GAI Models of the disclosed technology can be hosted on the portable user device and/or hosted on a separate computing device (e.g., a server) that is communicatively coupled to the portable user device.

To interpret prompts and commands input by frontline workers to the smart radio devices, GAI Models are configured to interpret natural language and both human-readable data and machine-generated data in real time or near real time. Natural language refers to the language spoken, written, or signed by humans for general-purpose communication, such as English, Spanish, Mandarin, and sign languages. Human-readable data is information that can be readily read and/or understood by humans without requiring any special tools or software. Examples of human-readable data include text files (.txt), HTML documents, printed books and articles, and spreadsheets with clear labels and data. In contrast, machine data (also referred to herein as “machine-generated data”) refers to data that is generated by computers, devices, and other digital systems in a format that is not immediately understandable by humans without processing or interpretation. This data is typically structured in a way that is optimized for machine processing and analysis. Examples of machine data include log files from servers and applications, sensor data from Internet of Things (IoT) devices, database records, and binary files and encoded data formats such as JSON and XML.

With the disclosed technology, a frontline worker can receive information about a worksite, or equipment and machines located thereat, by prompting a GAI Model through a portable user device. In one embodiment, the user presses a designated button on the portable user device to prompt the GAI Model. For example, a smart radio device can have a push-to-talk (PTT) button that the user must push before the smart radio device will listen through its microphone for speech that the GAI Model can interpret. The disclosed technology can interpret natural language included in the speech. Thus, the frontline worker can successfully prompt the GAI Model in an unstructured manner.

The GAI Model processes a prompt by accessing data available to the GAI Model or another GAI model about the worksite, machine, or machines in question. Data available to the GAI Model can include machine-generated data received directly from a relevant machine or machines based on sensors of those machines or other data processed locally at the machines. As such, the disclosed technology allows for communicative coupling between the portable user device, one or more GAI Models, and multiple machines. Additionally, data available to the GAI Models can include data received from external sources that store data for the worksite and the machines therein. Thus, the disclosed technology also allows for communicative coupling between the portable user device, the GAI Models, and one or more data storage devices.

In one example, a frontline worker prompts a GAI Model about the pressure of the hydraulic fluid within a hydraulic press at the worker's jobsite. Depending on how the jobsite stores data, with this prompt, the GAI Model can check the pressure sensor reading for the hydraulic fluid either directly from the hydraulic press, or from an external device that monitors the hydraulic fluid pressure or contains the most recent hydraulic fluid pressure record. Due to the AI system's ability to interpret both human-readable data and machine data, the GAI Models can obtain relevant information for a prompt regardless of the data type. For example, if the hydraulic fluid pressure sensor only records voltage, the AI system can obtain the voltage data and convert it into a pressure unit that the worker can understand. Or, if the pressure sensor records sensor data in psi, the AI system can communicate the sensor's recorded data in its native form to the worker.

The disclosed technology can also process a prompt by accessing user permissions data connected to the worker prompting the AI system. As such, if a worksite restricts a worker or a worker's role from seeing certain data, the AI system can recognize and enforce the restriction and not include restricted data when asked by the prompting worker. For example, when a contracted technician at a military base asks the AI system for the status of a machine, a GAI Model of the system can return simple information such as its age or battery life, but not return more sensitive information such as locations of its recent uses.

With the disclosed technology, once the AI system has processed a prompt, it can return an answer to the frontline worker through the portable user device. In one embodiment, a GAI Model of the system prompts a smart radio to return a natural language answer to the worker's prompt through the smart radio's speaker (e.g., “the hydraulic fluid pressure is currently 800 psi.”). In another embodiment, the GAI Model prompts a smart radio to return an answer to the worker's prompt through the smart radio's display.

The disclosed technology can process a frontline worker's commands included in prompts. For example, if the frontline worker knew (from a prior prompt or otherwise) that the hydraulic fluid pressure exceeds a threshold, the worker could command the AI system to turn off the hydraulic press. To do so, the AI system can process a worker's command with the same techniques described for processing a prompt. However, with a command, a GAI Model can translate natural language input by the worker into a machine command designed to control the relevant machine, or machines, as commanded by the worker. For example, if the worker commands the AI system to turn off the hydraulic press, a GAI Model can generate a machine command that is communicated to the hydraulic press which, when processed by a computing device that controls the hydraulic press, will cause the hydraulic press to turn off. Once a command is completed by the relevant machine or machines, the AI system can send a notification to the frontline worker through the portable user device indicating a successful command. Similar to processing a prompt, when the AI system processes a command, it can check user permissions to determine whether the jobsite allows the prompting worker to enforce such a command. Therefore, if a particular worker is not allowed to turn off a hydraulic press at their discretion, the GAI Model can deny their command and notify the prompting worker accordingly.

Mobile radio devices (e.g., smart radios) coupled to the AI system can be used to communicate between various workers. As the responsibilities of these workers adapt with technology, however, the functionality of mobile radio devices must evolve to provide additional functionality. For example, mobile radio devices have been improved to increase connectivity in previously disconnected locations. Moreover, improvements in mobile radio devices enable workers to communicate through additional forms of communication, often without user intervention. Mobile radio devices also provide a mechanism for tracking workers and equipment on a worksite to improve safety and efficiency. Mobile radio devices can further track details about employees during their work shift, and that information can be used to analyze the employees' strengths and weaknesses. Accordingly, the present disclosure relates to improvements in mobile radio devices. In general, improvements are directed to one of four technical aspects (“pillars”): network connectivity, collaboration, location services, and data, which are explained below.

Network connectivity: Smart radios operate using multiple onboard radios and connect to a set of known networks. This pillar refers to radio selection (e.g., use of multiple onboard radios in various contexts) and network selection (e.g., selecting which network to connect to from available networks in various contexts). These decisions may depend on data obtained from other pillars; however, inventions directed to the connectivity pillar have outputs that relate to improvements to network or radio communications/selections.

Collaboration: This pillar relates to communication between users. A collaboration platform includes chat channel selection, audio transcription and interpretation, sentiment analysis, and workflow improvements. The associated smart radio devices further include interface features that improve ease of communication through reduction in button presses and hands-free information delivery. Inventions in this pillar relate to improvements or gained efficiencies in communicating between users and/or the platform itself.

Location services: This pillar refers to various means of identifying the location of devices and people. There are straightforward or primary means, such as the Global Positioning System (GPS), accelerometer, or cellular triangulation. However, there are also secondary means by which known locations (via primary means) are used to derive the location of other unknown devices. For example, a set of smart radio devices with known locations are used to triangulate other devices or equipment. Further location services inventions relate to identification of the behavior of human users of the devices, e.g., micromotions of the device indicate that it is being worn, whereas lack of motion indicates that the device has been placed on a surface. Inventions in this pillar relate to the identification of the physical location of objects or workers.

Data: This pillar relates to the “Internet of Workers” (IoW) platform. Each of the other pillars leads to the collection of data. Implementation of that data into models provides valuable insights that illustrate a given worksite to users who are not physically present at that worksite. Such insights include productivity of workers, experience of workers, and accident or hazard mapping. Inventions in the data pillar relate to deriving insight or conclusions from one or more sources of data collected from any available sensor in the worksite.

Embodiments of the present disclosure will now be described with reference to the following figures. Although illustrated and described with respect to specific examples, embodiments of the present disclosure can be embodied in many different forms and should not be construed as limited to the embodiments set forth herein. Accordingly, the examples set forth herein are non-limiting examples referenced to improve the description of the present technology.

### Portable Wireless Apparatus

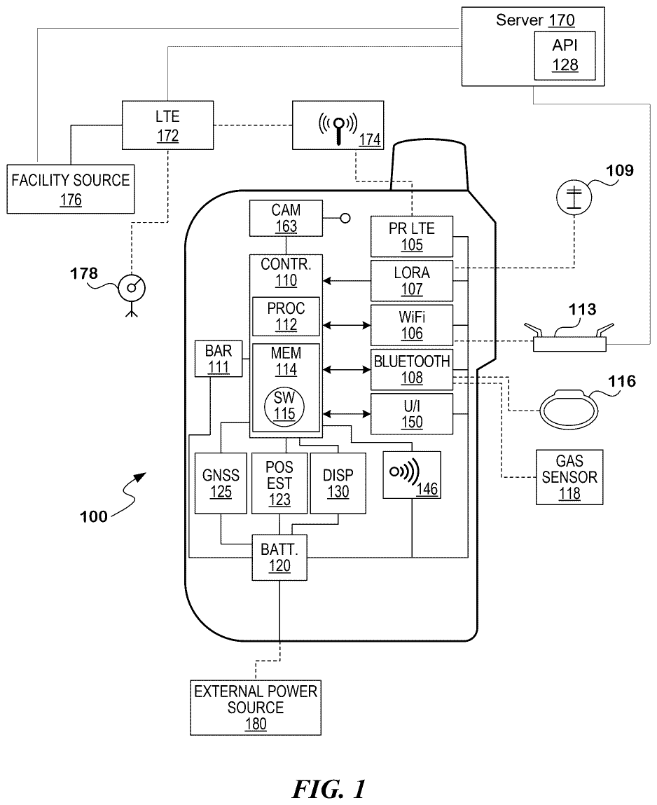

FIG. 1 is a block diagram illustrating an example architecture for an apparatus 100 for device communication and tracking, in accordance with one or more embodiments. The wireless apparatus 100 is implemented using components of the example computer system illustrated and described in more detail with reference to subsequent figures. In embodiments, the apparatus 100 is used to execute the ML system illustrated and described in more detail with reference to subsequent figures. The architecture shown by FIG. 1 is incorporated into a portable wireless apparatus 100, such as a smart radio, a smart camera, a smart watch, a smart headset, or a smart sensor. Although illustrated in a particular configuration, different embodiments of the apparatus 100 include different and/or additional components connected in different ways.

The apparatus 100 includes a controller 110 communicatively coupled either directly or indirectly to a variety of wireless communication arrangements. The apparatus 100 includes a position estimating component 123 (e.g., a dead-reckoning system), which estimates current position using inertia, speed, and intermittent known positions received from a position tracking component 125, which, in embodiments, is a Global Navigation Satellite System (GNSS) component. A battery 120 is electrically coupled with a cellular subsystem 105 (e.g., a private Long-Term Evolution (LTE) wireless communication subsystem), a Wi-Fi subsystem 106, a low-power wide area network (LPWAN) (e.g., LPWAN/long-range (LoRa) network subsystem 107), a Bluetooth subsystem 108, a barometer 111, an audio device 146, a user interface 150, and a built-in camera 163 for providing electrical power.

The battery 120 can be electrically and communicatively coupled with the controller 110 for providing electrical power to the controller 110 and to enable the controller 110 to determine a status of the battery 120 (e.g., a state of charge). In embodiments, the battery 120 is a non-removable rechargeable battery (e.g., using external power source 180). In this way, the battery 120 cannot be removed by a worker to power down the apparatus 100, or subsystems of the apparatus 100 (e.g., the position tracking component 125), thereby ensuring connectivity to the workforce throughout their shift. Moreover, the apparatus 100 cannot be disconnected from the network by removing the battery 120, thereby reducing the likelihood of device theft. In some cases, the apparatus 100 can include an additional, removable battery to enable the apparatus 100 to be used for prolonged periods without requiring additional charging time.

The controller 110 is, for example, a computer having a memory 114, including a non-transitory storage medium for storing software 115, and a processor 112 for executing instructions of the software 115. In some embodiments, the controller 110 is a microcontroller, a microprocessor, an integrated circuit (IC), or a system-on-a-chip (SoC). The controller 110 can include at least one clock capable of providing time stamps or displaying time via display 130. The at least one clock can be updatable (e.g., via the user interface 150, the position tracking component 125, the Wi-Fi subsystem 106, the private cellular network 107 subsystem, a server, or a combination thereof).

The wireless communications arrangement can include a cellular subsystem 105, a Wi-Fi subsystem 106, a LPWAN/LoRa network subsystem 107 wirelessly connected to a LPWAN network 109, or a Bluetooth subsystem 108 enabling sending and receiving. Cellular subsystem 105, in embodiments, enables the apparatus 100 to communicate with at least one wireless antenna 174 located at a facility (e.g., a manufacturing facility, a refinery, or a construction site), examples of which may be illustrated in and described with respect to the subsequent figures.

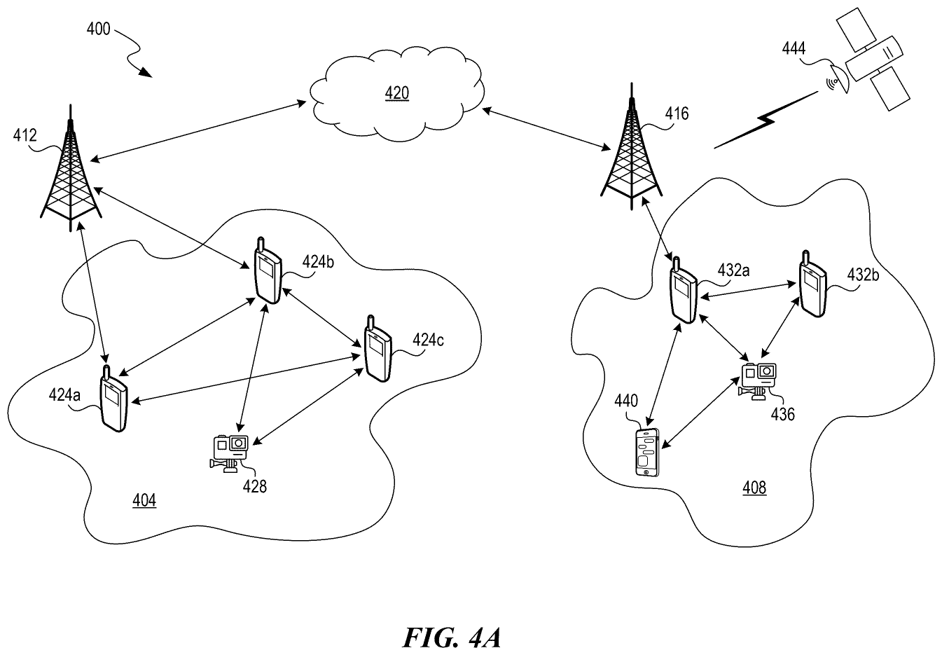

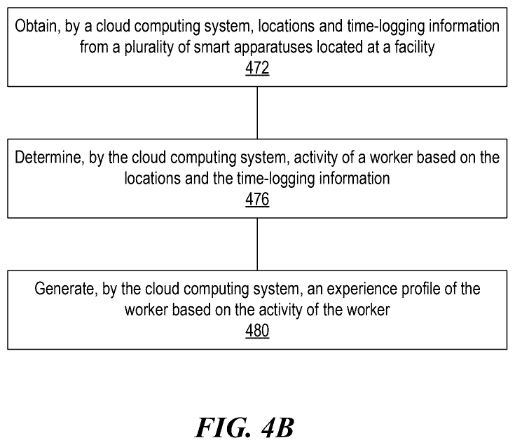

In embodiments, a cellular edge router arrangement 172 is provided for implementing a common wireless source. The cellular edge router arrangement 172 (sometimes referred to as an “edge kit”) can provide a wireless connection to the Internet. In embodiments, the LPWAN network 109, the wireless cellular network, or a local radio network is implemented as a local network for the facility usable by instances of the apparatus 100 (e.g., local network 404 illustrated in FIG. 4A). For example, the cellular type can be 2G, 3G, 4G, LTE, 5G, etc. The edge kit 172 is typically located near a facility's primary Internet source 176 (e.g., a fiber backhaul or other similar device). Alternatively, a local network of the facility is configured to connect to the Internet using signals from a satellite source, transceiver, or router 178, especially in a remotely located facility not having a backhaul source, or where a mobile arrangement not requiring a wired connection is desired. More specifically, the satellite source plus edge kit 172 is, in embodiments, configured into a vehicle, or portable system. In embodiments, the cellular subsystem 105 is incorporated into a local or distributed cellular network operating on any of the existing 88 different Evolved Universal Mobile Telecommunications System Terrestrial Radio Access (EUTRA) operating bands (ranging from 700 MHz up to 2.7 GHz). For example, the apparatus 100 can operate using a duplex mode implemented using time division duplexing (TDD) or frequency division duplexing (FDD).

The Wi-Fi subsystem 106 enables the apparatus 100 to communicate with an access point 113 capable of transmitting and receiving data wirelessly in a relatively high-frequency band. In embodiments, the Wi-Fi subsystem 106 is also used in testing the apparatus 100 prior to deployment. The Bluetooth subsystem 108 enables the apparatus 100 to communicate with a variety of peripheral devices, including a biometric interface device 116 and a gas/chemical detection sensor 118 used to detect noxious gases. In embodiments, numerous other Bluetooth devices are incorporated into the apparatus 100.

As used herein, the wireless subsystems of the apparatus 100 include any wireless technologies used by the apparatus 100 to communicate wirelessly (e.g., via radio waves) with other apparatuses in a facility (e.g., multiple sensors, a remote interface, etc.), and optionally with the Internet (“the cloud”) for accessing websites, databases, etc. For example, the apparatus 100 can be capable of connecting with a conference call or video conference at a remote conferencing server. The apparatus 100 can interface with a conferencing software (e.g., Microsoft Teams™, Skype™, Zoom™, Cisco Webex™). The wireless subsystems 105, 106, and 108 are each configured to transmit/receive data in an appropriate format, for example, in IEEE 802.11, 802.15, 802.16 Wi-Fi standards, Bluetooth standard, WinnForum Spectrum Access System (SAS) test specification (WINNF-TS-0065), and across a desired range. In embodiments, multiple mobile radio devices are connected to provide data connectivity and data sharing. In embodiments, the shared connectivity is used to establish a mesh network.

The apparatus 100 communicates with a host server 170 which includes API software 128. The apparatus 100 communicates with the host server 170 via the Internet using pathways such as the Wi-Fi subsystem 106 through an access point 113 and/or the wireless antenna 174. The API 128 communicates with onboard software 115 to execute features disclosed herein.

The position tracking component 125 and the position estimating component 123 operate in concert. The position tracking component 125 is used to track the location of the apparatus 100. In embodiments, the position tracking component 125 is a GNSS (e.g., GPS, Quasi-Zenith Satellite System (QZSS), BEIDOU, GALILEO, GLONASS) navigational device that receives information from satellites and determines a geographic position based on the received information. The position determined from the GNSS navigation device can be augmented with location estimates based on waves received from proximate devices. For example, the position tracking component 125 can determine a location of the apparatus 100 relative to one or more proximate devices using receives signal strength indicator (RSSI) techniques, time difference of arrival (TDOA) techniques, or any other appropriate techniques. The relative position can then be combined with the position of the proximate devices to determine a location estimate of the apparatus 100, which can be used to augment or replace other location estimates. In embodiments, a geographic position is determined at regular intervals (e.g., every five minutes, every minute, every five seconds), and the position in between readings is estimated using the position estimating component 123.

Position data is stored in memory 114 and uploaded to server at regular intervals (e.g., every five minutes, every minute, every five seconds). In embodiments, the intervals for recording and uploading position data are configurable. For example, if the apparatus 100 is stationary for a predetermined duration, the intervals are ignored or extended, and new location information is not stored or uploaded. If no connectivity exists for wirelessly communicating with server 170, location data can be stored in memory 114 until connectivity is restored, at which time the data is uploaded and then deleted from memory 114. In embodiments, position data is used to determine latitude, longitude, altitude, speed, heading, and Greenwich mean time (GMT), for example, based on instructions of software 115 or based on external software (e.g., in connection with server 170). In embodiments, position information is used to monitor worker efficiency, overtime, compliance, and safety, as well as to verify time records and adherence to company policies.

In some embodiments, a Bluetooth tracking arrangement using beacons is used for position tracking and estimation. For example, the Bluetooth subsystem 108 receives signals from Bluetooth Low Energy (BLE) beacons located about the facility. The controller 110 is programmed to execute relational distancing software using beacon signals (e.g., triangulating between beacon distance information) to determine the position of the apparatus 100. Regardless of the process, the Bluetooth subsystem 108 detects the beacon signals and the controller 110 determines the distances used in estimating the location of the apparatus 100.

In alternative embodiments, the apparatus 100 uses Ultra-Wideband (UWB) technology with spaced-apart beacons for position tracking and estimation. The beacons are small, battery-powered sensors that are spaced apart in the facility and broadcast signals received by a UWB component included in the apparatus 100. A worker's position is monitored throughout the facility over time when the worker is carrying or wearing the apparatus 100. As described herein, location-sensing GNSS and estimating systems (e.g., the position tracking component 125 and the position estimating component 123) can be used to primarily determine a horizontal location. In embodiments, the barometer 111 is used to determine a height at which the apparatus 100 is located (or operates in concert with the GNSS to determine the height) using known vertical barometric pressures at the facility. With the addition of a sensed height, a full three-dimensional location is determined by the processor 112. Applications of the embodiments include determining if a worker is, for example, on stairs or a ladder, atop or elevated inside a vessel, or in other relevant locations.

In embodiments, the display 130 is a touch screen implemented using a liquid-crystal display (LCD), an e-ink display, an organic light-emitting diode (OLED), or other digital display capable of displaying text and images. In embodiments, the display 130 uses a low-power display technology, such as an e-ink display, for reduced power consumption. Images displayed using the display 130 include, but are not limited to, photographs, video, text, icons, symbols, flowcharts, instructions, cues, and warnings.

The audio device 146 optionally includes at least one microphone (not shown) and a speaker for receiving and transmitting audible sounds, respectively. Although only one audio device 146 is shown in the architecture drawing of FIG. 1, it should be understood that in an actual physical embodiment, multiple speakers or microphones can be utilized to enable the apparatus 100 to adequately receive and transmit audio. In embodiments, the speaker has an output around 105 dB to be loud enough to be heard by a worker in a noisy facility. The microphone of the audio device 146 receives the spoken sounds and transmits signals representative of the sounds to the controller 110 for processing.

The apparatus 100 can be a shared device that is assigned to a particular user temporarily (e.g., for a shift). In embodiments, the apparatus 100 communicates with a worker ID badge using near field communication (NFC) technology. In this way, a worker may log in to a profile (e.g., stored at a remote server) on the apparatus 100 through their worker ID badge. The worker's profile may store information related to the worker. Examples include name, employee or contractor serial number, login credentials, emergency contact(s), address, shifts, roles (e.g., crane operator), calendars, or any other professional or personal information. Moreover, the user, when logged in, can be associated with the apparatus 100. When another user logs in to the apparatus 100, however, that user can then be associated with the apparatus 100.

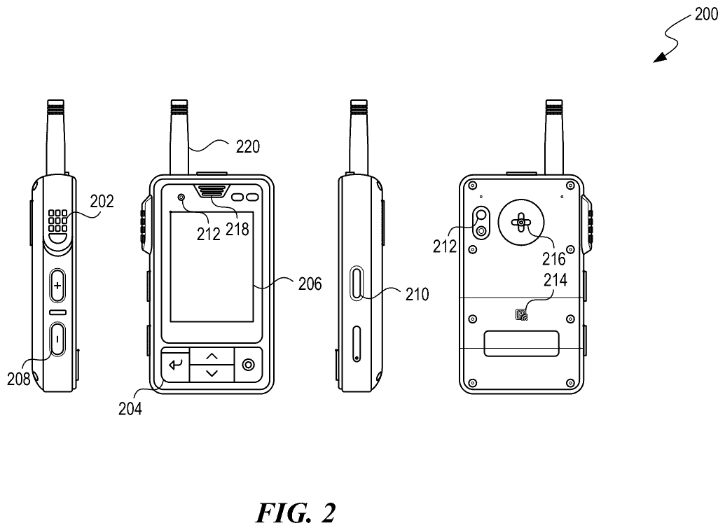

FIG. 2 is a drawing illustrating an example apparatus 200 for device communication and tracking, in accordance with one or more embodiments. The apparatus 200 includes a user interface that includes a PTT button 202, a 4-button user input system 204, a display 206, an easy to grab volume control 208, and a power button 210. The PTT button 202 can be used to control the transmission of data from or the reception of data by the apparatus 200. For example, the apparatus 200 may transmit audio data or other data when the PTT button 202 is pressed and receive audio data or other data when the PTT button 202 is released. In other examples, the PTT button 202 may control the transmission of audio data or other data from the apparatus 200 (e.g., transmit when the PTT button 202 is pressed), though apparatus 200 may transmit and receive audio data or other data at the same time (e.g., full duplex communication). The 4-button user input system 204 can be used to interact with the apparatus 200. For example, the 4-button user input system 204 can be used as a 4-direction input system (e.g., up-down-left-right), a 2-directional-enter-back (e.g., up-down-enter-back), or any other button configuration. The display 206 can output relevant visual information to the user. In aspects, the display 206 can enable touch input by the user to control the apparatus 200. The volume control 208 can control the loudness of the apparatus 200. The power button 210 can turn the apparatus 200 on and off.

The apparatus 200 further includes at least one camera 212, an NFC tag 214, a mount 216, at least one speaker 218, and at least one antenna 220. The camera 212 can be implemented as a front camera capturing the environment in front of the display 206 or a back camera capturing the environment opposite the display 206. The NFC tag 214 can be used to connect or register the apparatus 200. For example, the NFC tag 214 can register the apparatus 200 as being docked in a charging station. In yet another example, the NFC tag can connect to a workers badge to associate the apparatus with the worker. The mount 216 can be used to attach the apparatus 200 to the worker (e.g., on a utility belt of the worker). The speaker 218 can output audio received by or presented on the apparatus 200. The volume of the speaker 218 can be controlled by the volume control 208. The antenna 220 can be used to transmit data from the apparatus 200 or receive data at the apparatus 200. In some cases, transmission or reception by the antenna 220 can be controlled by the PTT button 202 or another button of the user interface.

### Charging Station

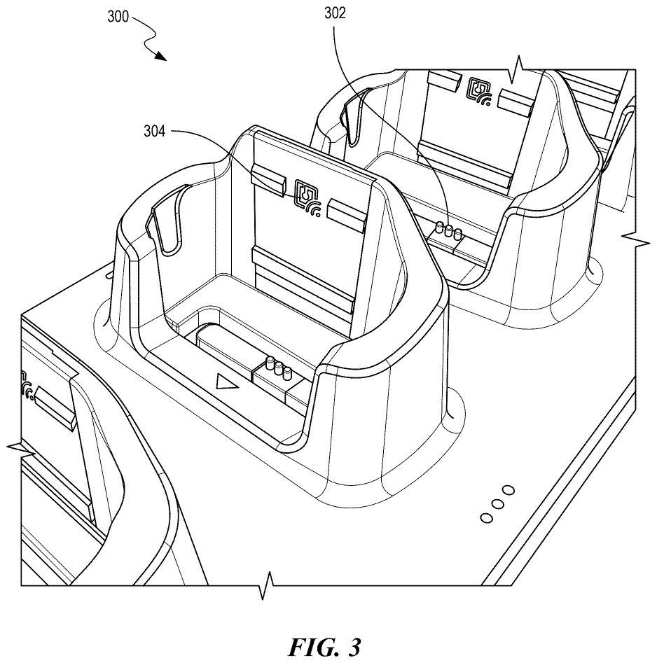

FIG. 3 is a drawing illustrating an example charging station 300 for apparatuses implementing device communication and tracking, in accordance with one or more embodiments. The charging station 300 can be used to dock one or more mobile radio devices for charging. In aspects, power can be supplied to the mobile radio devices docked at the charging station 300 through charging pins 302 located in each receptacle of the charging station 300. The charging pins 302 can be inserted into a charging port of the mobile radio devices. A worker clocking out at a facility can place a mobile radio device into the charging station 300. The mobile radio device can remain docked until it is removed from the charging station 300 by a worker clocking in at the facility.

The charging station 300 or the mobile radio device can determine when the mobile radio device has been docked in the charging station 300. For example, each receptacle of the charging station 300 can have an NFC pad 304 that connects with the mobile radio device when the mobile radio device is docked in that receptacle of the charging station 300. Alternatively or additionally, the mobile radio device can be determined to be docked in the charging station 300 when the charging pins 302 of a receptacle are inserted into the mobile radio device. In these ways, a cloud computing system can be made aware of the location and status (e.g., docked or removed) of the mobile radio device through communication with the charging station 300 or the mobile radio device.

### Communication Network

FIG. 4A is a drawing illustrating an example environment 400 for apparatuses and communication networks for device communication and tracking, in accordance with one or more embodiments. The environment 400 includes a cloud computing system 420, cellular transmission towers 412, 416, and local networks 404, 408. Components of the environment 400 are implemented using components of the example computer system illustrated and described in more detail with reference to subsequent figures. Likewise, different embodiments of the apparatus 100 include different and/or additional components and are connected in different ways.

Smart radios 424 (e.g., smart radios 424a-424c), smart radios 432 (e.g., smart radios 432a-b) and smart cameras 428, 436 are implemented in accordance with the architecture shown by FIG. 1. In embodiments, smart sensors implemented in accordance with the architecture shown by FIG. 1 are also connected to the local networks 404, 408 and mounted on a surface of a worksite, or worn or carried by workers. For example, the local network 404 is located at a first facility and the local network 408 is at a second facility. In embodiments, each smart radio and other smart apparatus has two Subscriber Identity Module (SIM) cards, sometimes referred to as dual SIM. A SIM card is an IC intended to securely store an international mobile subscriber identity (IMSI) number and its related key, which are used to identify and authenticate subscribers on mobile telephony devices.

A first SIM card enables the smart radio 424a to connect to the local (e.g., cellular) network 404 and a second SIM card enables the smart radio 424a to connect to a commercial cellular tower (e.g., cellular transmission tower 412) for access to mobile telephony, the Internet, and the cloud computing system 420 (e.g., to major participating networks such as Verizon™, AT&T™, or T-Mobile™). In such embodiments, the smart radio 424a has two radio transceivers, one for each SIM card. In other embodiments, the smart radio 424a has two active SIM cards, and the SIM cards both use only one radio transceiver. However, the two SIM cards are both active only as long as both are not in simultaneous use. As long as the SIM cards are both in standby mode, a voice call could be initiated on either one. However, once the call begins, the other SIM card becomes inactive until the first SIM card is no longer actively used.

In embodiments, the local network 404 uses a private address space of Internet protocol (IP) addresses. In other embodiments, the local network 404 is a local radio-based network using peer-to-peer (P2P) two-way radio (duplex communication) with extended range based on hops (e.g., from smart radio 424a to smart radio 424b to smart radio 424c). Hence, radio communication is transferred similarly to addressed packet-based data with packet switching by each smart radio or other smart apparatus on the path from source to destination. For example, each smart radio or other smart apparatus operates as a transmitter, receiver, or transceiver for the local network 404 to serve a facility. The smart apparatuses serve as multiple transmit/receive sites interconnected to achieve the range of coverage required by the facility. Further, the signals on the local networks 404, 408 are backhauled to a central switch for communication to the cellular transmission towers 412, 416.

In embodiments (e.g., in more remote locations), the local network 404 is implemented by sending radio signals between multiple smart radios 424. Such embodiments are implemented in less-inhabited locations (e.g., wilderness) where workers are spread out over a larger work area that may be otherwise inaccessible to commercial cellular service. An example is where power company technicians are examining or otherwise working on power lines over larger distances that are often remote. The embodiments are implemented by transmitting radio signals from a smart radio 424a to other smart radios 424b, 424c on one or more frequency channels operating as a two-way radio. The radio messages sent include a header and a payload. Such broadcasting does not require a session or a connection between the devices. Data in the header is used by a receiving smart radio 424b to direct the “packet” to a destination (e.g., smart radio 424c). At the destination, the payload is extracted and played back by the smart radio 424c via the radio's speaker.

For example, the smart radio 424a broadcasts voice data using radio signals. Any other smart radio 424 b within a range limit (e.g., 1 mile, 2 miles, etc.) receives the radio signals. The radio data includes a header having the destination of the message (smart radio 424c). The radio message is decrypted/decoded and played back on only the destination smart radio 424c. If another smart radio 424b that was not the destination radio receives the radio signals, the smart radio 424b rebroadcasts the radio signals rather than decoding and playing them back on a speaker. The smart radios 424 are thus used as signal repeaters. The advantages and benefits of the embodiments disclosed herein include extending the range of two-way radios or smart radios 424 by implementing radio hopping between the radios.

In embodiments, the local network 404 is implemented using Citizens Broadband Radio Service (CBRS). The use of CBRS Band 48 (from 3550 MHz to 3700 MHz), in embodiments, provides numerous advantages. For example, the use of CBRS Band 48 provides longer signal ranges and smoother handovers. The use of CBRS Band 48 supports numerous smart radios 424 and smart cameras 428 at the same time. A smart apparatus is therefore sometimes referred to as a Citizens Broadband Radio Service Device (CBSD).

In alternative embodiments, the Industrial, Scientific, and Medical (ISM) radio bands are used instead of CBRS Band 48. It should be noted that the particular frequency bands used in executing the processes herein could be different, and that the aspects of what is disclosed herein should not be limited to a particular frequency band unless otherwise specified (e.g., 4G-LTE or 5G bands could be used). In embodiments, the local network 404 is a private cellular (e.g., LTE) network operated specifically for the benefit of the facility. Only authorized users of the smart radios 424 have access to the local network 404. For example, the local network 404 uses the 900 MHz spectrum. In another example, the local network 404 uses 900 MHz for voice and narrowband data for Land Mobile Radio (LMR) communications, 900 MHz broadband for critical wide area, long-range data communications, and CBRS for ultra-fast coverage of smaller areas of the facility, such as substations, storage yards, and office spaces.

The smart radios 424 can communicate using other communication technologies, for example, Voice over IP (VoIP), Voice over Wi-Fi (VoWiFi), or Voice over Long-Term Evolution (VoLTE). The smart radios 424 can connect to a communication session (e.g., voice call, video call) for real-time communication with specific devices. The communication sessions can include devices within or outside of the local network 404 (e.g., in the local network 408). The communication sessions can be hosted on a private server (e.g., of the local network 404) or a remote server (e.g., accessible through the cloud computing system 420). In other aspects, the session can be P2P.

The cloud computing system 420 delivers computing services—including servers, storage, databases, networking, software, analytics, and intelligence—over the Internet to offer faster innovation, flexible resources, and economies of scale. FIG. 4A depicts an exemplary high-level, cloud-centered network environment 400 otherwise known as a cloud-based system. Referring to FIG. 4A, it can be seen that the environment centers around the cloud computing system 420 and the local networks 404, 408. Through the cloud computing system 420, multiple software systems are made to be accessible by multiple smart radios 424, 432, smart cameras 428, 436, as well as more standard devices (e.g., a smartphone 440 or a tablet) each equipped with local networking and cellular wireless capabilities. Each of the apparatuses 424, 428, 440, although diverse, can embody the architecture of the apparatus 100 shown by FIG. 1, but are distributed to different kinds of users or mounted on surfaces of the facility. For example, the smart radio 424a is worn by employees or independently contracted workers at a facility. The CBRS-equipped smartphone 440 is utilized by an on- or offsite supervisor. The smart camera 428 is utilized by an inspector or another person wanting to have improved display or other options. Regardless, it should be recognized that numerous apparatuses are utilized in combination with an established cellular network (e.g., CBRS Band 48 in embodiments) to provide the ability to access the cloud software applications from the apparatuses (e.g., smart radios 424, 432, smart cameras 428, 436, smartphone 440).

In embodiments, the cloud computing system 420 and local networks 404, 408 are configured to send communications to the smart radios 424, 432 or smart cameras 428, 436 based on analysis conducted by the cloud computing system 420. The communications enable the smart radio 424 or smart camera 428 to receive warnings, etc., generated as a result of analysis conducted. The employee-worn smart radio 424a (and possibly other devices including the architecture of the apparatus 100, such as the smart cameras 428, 436) is used along with the peripherals shown in FIG. 1 to accomplish a variety of objectives. For example, workers, in embodiments, are equipped with a Bluetooth-enabled gas-detection smart sensor. The smart sensor detects the existence of a dangerous gas, or gas level. By connecting through the smart radio 424a or directly to the local network 404, the readings from the smart sensor are analyzed by the cloud computing system 420 to implement a course of action due to sensed characteristics of toxicity. The cloud computing system 420 sends out an alert to the smart radio 424 or smart camera 428, and thus a worker, for example, uses a speaker or alternative notification means to alert other workers so that they can avoid danger.

### Position Estimation

The environment 400 can include one or more satellites 444. The smart radios 424 can receive signals from the satellites 444 that are usable to determine position estimates. For example, the smart radios 424 include a positioning system that implements a GNSS or other network triangulation/position system. In some embodiments, the locations of the smart radios 424 are determined from satellites, for example, GPS, QZSS, BEIDOU, GALILEO, and GLONASS. In some cases, the position determined from the primary positioning system does not satisfy a minimum accuracy requirement, the primary position can only be determined at predetermined intervals, or the primary position cannot be determined at all. Accordingly, additional positioning techniques can be used to augment or replace primary positioning. For example, the smart radio 424a can track its position based on broadcast signals received from proximate devices (e.g., using RSSI techniques or TDOA techniques). In some embodiments, the proximate devices include devices that have transmission ranges that encompass the location of the smart radio 424a (e.g., smart radios 424b, 424c). In some embodiments, the smart radios 424 determine or augment a secondary position estimate based on broadcasts received from a cellular communication tower (e.g., cellular transmission tower 412).

RSSI techniques include using the strength signals within a broadcast signal to determine the distance of a receiver from a transmitter. For instance, a receiver is enabled to determine the signal-to-noise ratio (SNR) of a received signal within a broadcast from a transmitter. The SNR of receive signal can be related to the distance between a receiver and a transmitter. Thus, the distance between the receiver and the transmitter can be estimated based on the SNR. By determining a receiver's distance from multiple transmitters, the receiver's position can be determined through localization (e.g., triangulation). In some cases, RSSI techniques become less accurate at larger distances. Accordingly, proximate devices may be required to be within a particular distance for RSSI techniques.

TDOA techniques include using the timing at which broadcast signals are received to determine the distance of a receiver from a transmitter. For example, a broadcast signal is sent by a transmitter at a known time (e.g., predetermined intervals). Thus, by determining the time at which the broadcast signal is received (e.g., using a clock), the travel time of the broadcast signal can be determined. The distance of the smart radios 424 from one another can thus be determined based on the wave speed. In some implementations, as broadcast signals are received from the transmitters, the smart radios 424 determine its relative position from each transmitter through localization, resulting in a more accurate global position (e.g., triangulation). Thus, TDOA techniques can be used to determine device location.

In aspects, the broadcast signals transmitted by proximate devices include information related to a position. For example, broadcast signals sent from the smart radios 424 identify their current location. Broadcast signals sent from cellular communication towers or other stationary devices may not need to include a current location, as the location may be known to the receiving device. In other cases, a cellular communication tower or other stationary device sends a broadcast signal that includes information indicative of a current location of the tower or stationary device. Using the current location of the transmitting devices and the location of the smart radios (e.g., smart radios 424b, 424c) relative to the transmitting devices, a global position of the smart radio 424a can be determined.

In some cases, a barometer is used to augment the position determination of the smart radios 424. For example, RSSI, TDOA, and other techniques are used to determine the distance between a transmitter and a receiver. However, these techniques may not provide information related to the displacement between the transmitter and the receiver (e.g., whether the distance is in the x, y, or z plane). In some cases, the barometer is used to provide relative displacement information (e.g., based on atmospheric conditions) of the smart radios 424. In aspects, the broadcast signals received from the proximate devices include information relating to respective elevation estimates (e.g., determined by barometers at the proximate devices) at each of the proximate devices. The elevation estimates from the proximate devices are compared to the elevation estimate of the smart radio 424a to determine the difference in elevation between the smart radio 424a and the proximate devices (e.g., smart radios 424b, 424c).

In some cases, a target device estimates a location based on proximate devices without analyzing broadcast signals. For example, proximate devices shares their calculated location data. The target device (e.g., smart radio 424a) receives location data via any communication technology (e.g., Bluetooth or another short-range communication). One device (e.g., smart radio 424b) shares that it is at location A and another device (e.g., smart radio 424c) is at location B. The target device estimates that it's located somewhere near A and B (e.g., within a communication range of A and B using the respective communication mechanism). In another aspect, the target device receives location data from multiple proximate devices and combines (e.g., average) the location data to estimate its position. In yet another example, the target device receives location data from proximate devices via a first communication and uses a second communication to determine the location of the target device relative to the proximate devices. In this way, the location data need not be communicated in the same communication used to determine the relative location of the target device.

As an example, the smart radio 424b determines its location based on a primary location estimate that is augmented with a secondary location estimate. For example, the smart radio 424b receives a primary location estimate. In aspects, the primary location estimate is a GNSS location determined from the satellite 444 or a location estimate determined by communications with the cellular communication tower 412 (e.g., using TDOA, RSSI, or other techniques). In some implementations, the primary location estimate has a measurement error less than 1 foot, 2 feet, 5 feet, 10 feet, or the like. The measurement error may increase based on an environment of the smart radio 424b. For example, the measurement error may be higher if the smart radio 424b is within or surrounded by a densely constructed building.

To improve the measurement accuracy, the smart radio 424b can augment its primary location estimate based on a secondary location estimate. In aspects, the secondary location estimate is determined from broadcast signals transmitted by smart radio 424a, smart radio 424c, smart camera 428, cellular communication tower 412, or another communication device or node (e.g., an access point). Positioning techniques (e.g., TDOA, RSSI, location sharing, or other techniques) can be used to determine a relative distance from the transmitting device. For example, smart radio 424a, smart radio 424c, and smart camera 428 transmit broadcast signals that enable the distance of the smart radio 424b to be determined relative to each transmitting device. The transmitting devices can be stationary or moving. Stationary objects typically have strong or high confidence location data (e.g., immobile objects are plotted accurately to maps). The relative location of the smart radio 424b is determined through triangulation based on the distance from each transmitting device. In aspects, the secondary location estimate has a measurement error of less than 1 inch, 2 inches, 6 inches, or 1 foot. In aspects, the secondary location estimate replaces with the primary location estimate or is averaged with the primary location estimate to determine an augmented position estimate with reduced error. Accordingly, the measurement error of the location estimate of the smart device 424b can be improved by augmenting the primary location estimate with the secondary location estimate.

In some implementations, The location of the equipment is similarly monitored. In this context, mobile equipment refers to worksite or facility industrial equipment (e.g., heavy machinery, precision tools, construction vehicles). According to example embodiments, a location of a mobile equipment is continuously monitored based on repeated triangulation from multiple smart radios 424 located near the mobile equipment (e.g., using tags placed on the mobile equipment). Improvements to the operation and usage of the mobile equipment are made based on analyzing the locations of the mobile equipment throughout a facility or worksite. Locations of the mobile equipment are reported to owners of the mobile equipment or entities that own, operate, and/or maintain the mobile equipment. Mobile equipment whose location is tracked includes vehicles, tools used and shared by workers in different facility locations, toolkits and toolboxes, manufactured and/or packaged products, and/or the like. Generally, mobile equipment is movable between different locations within the facility or worksite at different points in time.

Various monitoring operations are performed based on the locations of the mobile equipment that are determined over time. In some embodiments, a usage level for the mobile equipment is automatically classified based on different locations of the mobile equipment over time. For example, a mobile equipment having frequent changes in location within a window of time (e.g., different locations that are at least a threshold distance away from each other) is classified at a high usage level compared to a mobile equipment that remains in approximately the same location for the window of time. In some embodiments, certain mobile equipment classified with high usage levels are indicated and identified to maintenance workers such that usage-related failures or faults can be preemptively identified.

In some embodiments, a resting or storage location for the mobile equipment is determined based on the monitoring of the mobile equipment location. For example, an average spatial location is determined from the locations of the mobile equipment over time. A storage location based on the average spatial location is then indicated in a recommendation provided or displayed to an administrator or other entity that manages the facility or worksite.

In some embodiments, locations of multiple mobile equipment are monitored so that a particular mobile equipment is recommended for use to a worker during certain events or scenarios. As another example, for a worker assigned with a maintenance task at a location within a facility, one or more maintenance toolkits shared among workers and located near the location are recommended to the worker for use.

Accordingly, embodiments described herein provide local detection and monitoring of mobile equipment locations. Facility operation efficiency is improved based on the monitoring of mobile equipment locations and analysis of different mobile equipment locations.

### Machine-Defined Interactions

The cloud computing system 420 uses data received from the smart radios 424, 432 and smart cameras 428, 436 to track and monitor machine-defined activity of workers based on locations worked, times worked, analysis of video received from the smart cameras 428, 436, etc. The activity is measured by the cloud computing system 420 in terms of at least one of a start time, a duration of the activity, an end time, an identity (e.g., serial number, employee number, name, seniority level, etc.) of the worker performing the activity, an identity of the equipment(s) used by the worker, or a location of the activity. For example, a smart radio 424a carried or worn by a worker would track that the position of the smart radio 424a is in proximity to or coincides with a position of the particular machine.

The activity is measured by the cloud computing system 420 in terms of at least the location of the activity and one of a duration of the activity, an identity of the worker performing the activity, or an identity of the equipment(s) used by the worker. In embodiments, the ML system is used to detect and track activity, for example, by extracting features based on equipment types or manufacturing operation types as input data. For example, a smart sensor mounted on an oil rig transmits to and receives signals from a smart radio 424a carried or worn by a worker to log the time the worker spends at a portion of the oil rig.

Worker activity involving multiple workers can similarly be monitored. These activities can be measured by the cloud computing system 420 in terms of at least one of a start time, a duration of the activity, an end time, identities (e.g., serial numbers, employee numbers, names, seniority levels, etc.) of the workers performing the activity, an identity of the equipment(s) used by the workers, or a location of the activity. Group activities are detected and monitored using location tracking of multiple smart apparatuses. For example, the cloud computing system 420 tracks and records a specific group activity based on determining that two or more smart radios 424 were located in proximity to one another within a particular worksite for a predetermined period of time. For example, a smart radio 424a transmits to and receives signals from other smart radios 424b, 424c carried or worn by other workers to log the time the worker spends working together in a team with the other workers.

In embodiments, a smart camera 428 mounted at the worksite captures video of one or more workers working in the facility and performs facial recognition (e.g., using the ML system). The smart camera 428 can identify the equipment used to perform an activity or the tasks that a worker is performing. The smart camera 428 sends the location information to the cloud computing system 420 for generation of activity data. In embodiments, an ML system is used to detect and track activity (e.g., using features based on geographic locations or facility types as input data).

The cloud computing system 420 can determine various metrics for monitored workers based on the activity data. For example, the cloud computing system 420 can determine a response time for a worker. The response time refers to the time difference between receiving a call to report to a given task and the time of arriving at a geofence associated with the task. In aspects, the cloud computing system 420 can determine a repair metric, which measures the effectiveness of repairs by a worker, based on the activity data. For example, the effectiveness of repairs is machine observable based on a length of time a given object remains functional as compared to an expected time of functionality (e.g., a day, a few months, a year, etc.). In yet another aspect, the activity data can be analyzed to determine efficient routes to different areas of a worksite, for example, based on routes traveled by monitored workers. Activity data can be analyzed to determine the risk to which each worker is exposed, for example, based on how much time a worker spends in proximity to hazardous material or performing hazardous tasks. The ML system can analyze the various metrics to monitor workers or reduce risk.

### Worker Experience Profile

The cloud computing system 420 hosts the software functions to track activities to determine performance metrics and time spent at different tasks and with different equipment and to generate work experience profiles of frontline workers based on interfacing between software suites of the cloud computing system 420 and the smart radios 424, 432, smart cameras 428, 436, smartphone 440. Tracking of activities is implemented in, for example, Scheduling Systems (SS), Field Data Management (FDM) systems, and/or Enterprise Resource Planning (ERP) software systems that are used to track and plan for the use of facility equipment and other resources. Manufacturing Management System (MMS) software is used to manage the production and logistics processes in manufacturing industries (e.g., for the purpose of reducing waste, improving maintenance processes and timing, etc.). Risk-Based Inspection (RBI) software assists the facility using optimized maintenance business processes to examine equipment and/or structures, and track activities prior to and after a breakdown in equipment, detection of manufacturing failures, or detection of operational hazards (e.g., detection of gas leaks in the facility). The amount of time each worker logs at a machine-defined activity with respect to different locations and different types of equipment is collected and used to update an “experience profile” of the worker on the cloud computing system 420 in real time.

FIG. 4B is a flow diagram illustrating an example process for generating a work experience profile using smart radios 424a, 424b, and local networks 404, 408 for device communication and tracking, in accordance with one or more embodiments. The smart radios 424 and local networks 404, 408 are illustrated and described in more detail with reference to FIG. 4A. In embodiments, the process of FIG. 4B is performed by the cloud computing system 420 illustrated and described in more detail with reference to FIG. 4A. In embodiments, the process of FIG. 4A is performed by a computer system, for example, the example computer system illustrated and described in more detail with reference to subsequent figures. Particular entities, for example, the smart radios 424 or the local network 404, perform some or all of the steps of the process in embodiments. Likewise, embodiments can include different and/or additional steps, or perform the steps in different orders.

At 472, the cloud computing system 420 obtains locations and time-logging information from multiple smart apparatuses (e.g., smart radios 424) located at a facility. The locations describe movement of the multiple smart apparatuses with respect to the time-logging information. For example, the cloud computing system 420 keeps track of shifts, types of equipment, and locations worked by each worker, and uses the information to develop the experience profile automatically for the worker, including formatting services. When the worker joins an employer or otherwise signs up for the service, relevant personal information is obtained by the cloud computing system 420 to establish payroll and other known employment particulars. The worker uses a smart radio 424a to engage with the cloud computing system 420 and works shifts for different positions.

At 476, the cloud computing system 420 determines activity of a worker based on the locations and the time-logging information. The activities describe work performed by one or more workers with equipment of the facility (e.g., lathes, lifts, crane, etc.). For example, the activities can include tasks performed by the worker, equipment worked with by the worker, time spent on a task or with a piece of equipment, or any other relevant information. In some cases, the activities can be used to log accidents that occur at the worksite. The activities can also include various performance metrics determined from the location and the time-logging information.

At 480, the cloud computing system 420 generates the experience profile of the worker based on the activity of the worker. The cloud computing system 420 automatically fills in information determined from the activity of the worker to build the experience profile of the worker. The data filled into the field space of the experience profile can include the specific number of hours that a worker has spent working with a particular type of equipment (e.g., 200 hours spent driving forklifts, 150 hours spent operating a lathe, etc.). The experience profile can further include various performance metrics associated with a particular task or piece of equipment. In embodiments, the cloud computing system 420 exports or publishes the experience profile to a user profile of a social or professional networking platform (e.g., such as LinkedIn™, Monster™, any other suitable social media or proprietary website, or a combination thereof). In embodiments, the cloud computing system 420 exports the experience profile in the form of a recommendation letter or reference package to past or prospective employers. The experience data enables a given worker to prove that they have a certain amount of experience with a given equipment platform.

### Example Facility

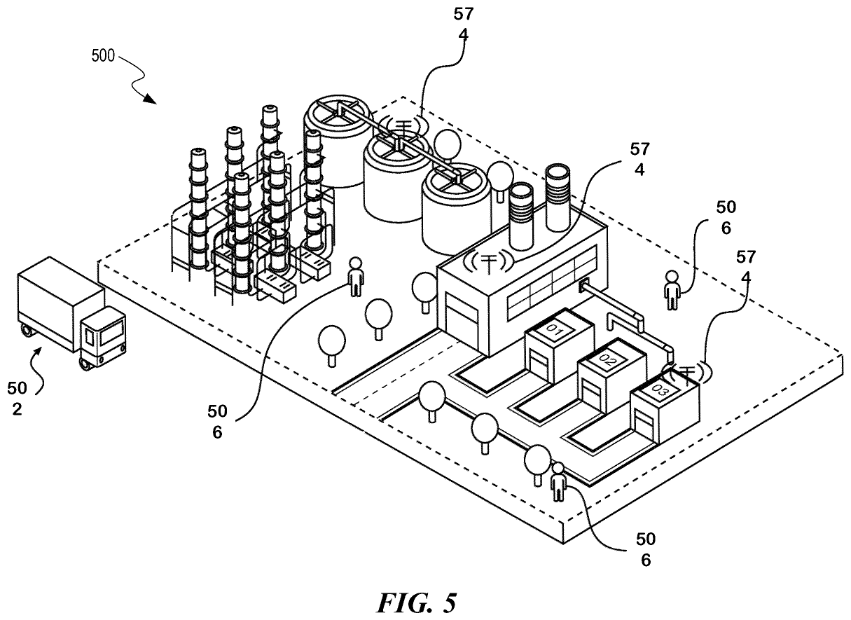

FIG. 5 is a drawing illustrating an example facility 500 using apparatuses and communication networks for device communication and tracking, in accordance with one or more embodiments. For example, the facility 500 is a refinery, a manufacturing facility, a construction site, etc. The communication technology shown by FIG. 5 can be implemented using components of the example computer systems illustrated and described in more detail with reference to the other figures herein.

Multiple differently and strategically placed wireless antennas 574 are used to receive signals from an Internet source (e.g., a fiber backhaul at the facility), or a mobile system (e.g., a truck 502). The truck 502, in embodiments, can implement an edge kit used to connect to the Internet. The strategically placed wireless antennas 574 repeat the signals received and sent from the edge kit such that a private cellular network is made available to multiple workers 506. Each worker carries or wears a cellular-enabled smart radio, implemented in accordance with the embodiments described herein. A position of the smart radio is continually tracked during a work shift.

In implementations, a stationary, temporary, or permanently installed cellular (e.g., LTE or 5G) source is used that obtains network access through a fiber or cable backhaul. In embodiments, a satellite or other Internet source is embodied into hand-carried or other mobile systems (e.g., a bag, box, or other portable arrangement). FIG. 5 shows that multiple wireless antennas 574 are installed at various locations throughout the facility. Where the edge kit is located at a location near a facility fiber backhaul, the communication system in the facility 500 uses multiple omnidirectional Multi-Band Outdoor (MBO) antennas as shown. Where the Internet source is instead located near an edge of the facility 500, as is often the case, the communication system uses one or more directional wireless antennas to improve the coverage in terms of bandwidth. Alternatively, where the edge kit is in a mobile vehicle, for example, truck 502, the antennas' directional configuration would be picked depending on whether the vehicle would ultimately be located at a central or boundary location.

In embodiments where a backhaul arrangement is installed at the facility 500, the edge kit is directly connected to an existing fiber router, cable router, or any other source of Internet at the facility. In embodiments, the wireless antennas 574 are deployed at a location in which the smart radio is to be used. For example, the wireless antennas 574 are omnidirectional, directional, or semidirectional depending on the intended coverage area. In embodiments, the wireless antennas 574 support a local cellular network. In embodiments, the local network is a private LTE network (e.g., based on 4G or 5G). In more specific embodiments, the network is a CBRS Band 48 local network. The frequency range for CBRS Band 48 extends from 3550 MHz to 3700 MHz and is executed using TDD as the duplex mode. The private LTE wireless communication device is configured to operate in the private network created, for example, to accommodate CBRS Band 48 in the frequency range for Band 48 (again, from 3550 MHz to 3700 MHz) and accommodates TDD. Thus, channels within the preferred range are used for different types of communications between the cloud and the local network.

### Geofencing

As described herein, smart radios are configured with location estimating capabilities and are used within a facility or worksite for which geofences are defined. A geofence refers to a virtual perimeter for a real-world geographic area, such as a portion of a facility or worksite. A smart radio includes location-aware devices that inform of the location of the smart radio at various times. Embodiments described herein relate to location-based features for smart radios or smart apparatuses. Location-based features described herein use location data for smart radios to provide improved functionality. In some embodiments, a location of a smart radio (e.g., a position estimate) is assumed to be representative of a location of a worker using or associated with the smart radio. As such, embodiments described herein apply location data for smart radios to perform various functions for workers of a facility or worksite.

Some example scenarios that require radio communication between workers are area-specific, or relevant to a given area of a facility. For example, when machines need repair, workers near the machine can be notified and provided instructions to assist in the repair. Alternatively, if a hazard is present at the facility, workers near the hazard can be notified.

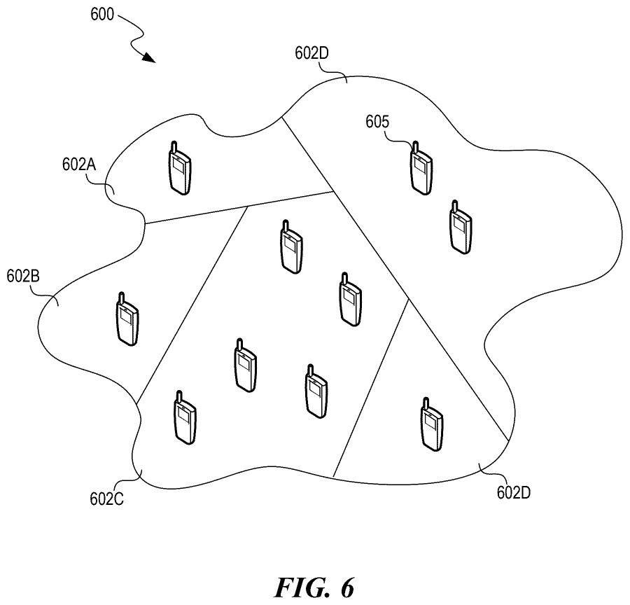

According to some embodiments, locations of smart radios are monitored such that at a point in time, each smart radio located in a specific geofenced area is identified. FIG. 6 illustrates an example of a worksite 600 that includes a plurality of geofenced areas 602, with smart radios 605 being located within the geofenced areas 602.

In some embodiments, an alert, notification, communication, and/or the like is transmitted to each smart radio 605 that is located within a geofenced area 602 (e.g., 602C) responsive to a selection or indication of the geofenced area 602. A smart radio 605, an administrator smart radio (e.g., a smart radio assigned to an administrator), or the cloud computing system is configured to enable user selection of one of the plurality of geofenced areas 602 (e.g., 602C). For example, a map display of the worksite 600 and the plurality of geofenced areas 602 is provided. With the user selection of a geofenced area 602 and a location for each smart radio 605, a set of smart radios 605 located within the geofenced area 602 is identified. An alert, notification, communication, and/or the like is then transmitted to the identified smart radios 605.

### Internet of Workers Platform With Artificial Intelligence

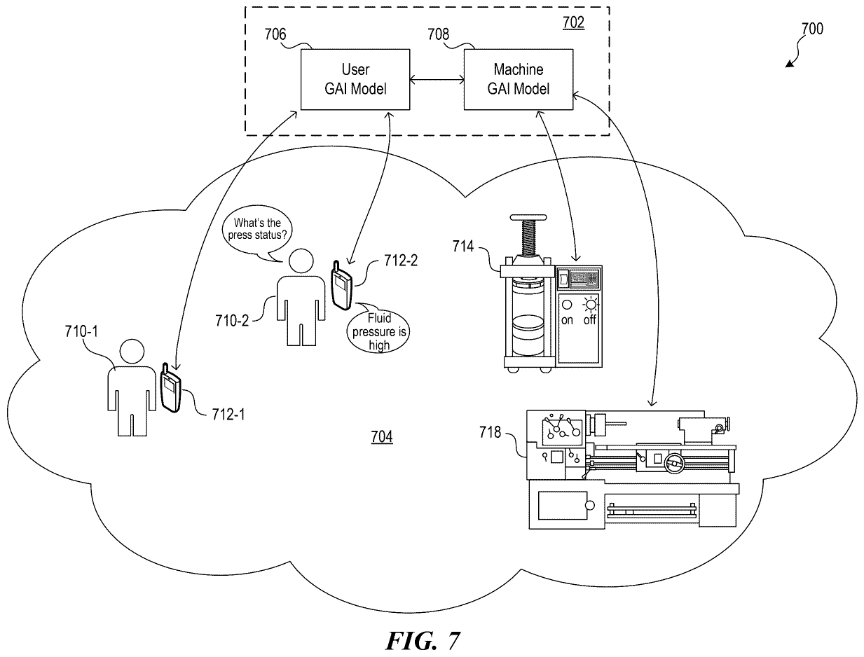

FIG. 7 illustrates a system 700 of an IoW platform that integrates an AI system 702 configured to enable the exchange of communications between frontline workers and industrial machines at a worksite 704 through portable user devices (e.g., smart radio devices). The AI system 702 includes GAI Models 706 and 708, each configured to interpret prompts from either workers or machines to generate prompts, responses, or commands that cause industrial machines to perform actions, for example. The AI system 702 can include any number of GAI Models that are chained or layered to exchange communications between entities that have different native languages. In some embodiments, the AI system 702 is activated when a triggering word is detected in an utterance captured at a portable user device used by a worker, or when a push-to-talk (PTT) button is actuated at the portable user device.

As illustrated, the worksite 704 includes workers 710-1 and 710-2 (collectively referred to herein as “workers 710”) utilizing smart radios 712-1 and 712-2 (collectively referred to herein as “smart radio devices 712”), respectively. Additionally, the worksite 704 includes two machines: a hydraulic press 714 and a lathe 718. In the depicted scenario, the worker 710-2 intends to check the status of the hydraulic press 714 by entering a prompt into the smart radio 712-2. The prompt can be provided in various formats. For instance, the worker 710-2 can speak into the microphone of the smart radio 712-2, which detects an utterance such as “What's the press status?”. This utterance constitutes an unstructured natural language prompt. Alternatively, the prompt can be input as text by the worker 710-2 into the smart radio 712-2. Instead of speaking “What's the press status?” into the microphone, the worker 710-2 could type “What's the press status?” into the smart radio 712-2. Furthermore, the prompt may include a physical gesture made by the worker 710-2, which is captured by a camera or other sensor on the smart radio 712-2. For example, the worker 710-2 could use sign language to gesture “What's the press status?” through the camera of the smart radio 712-2.

The GAI Models 706 and 708 of the AI system 702 interface with each other, and with the smart radio devices 712 or the machines 714 and 718. For instance, the workers 710 can input prompts that include commands into the smart radio devices 712, which are processed by the user GAI Model 706 in a natural language format. This generates prompts for the machine GAI Model 708, which produces machine commands in a machine language format that instructs the machines 714, 718 to perform specific actions. Similarly, the machines 714, 718 can produce prompts in a machine language format that are processed by the machine GAI Model 708, which then generates prompts for the user GAI Model 706, resulting in natural language outputs for the workers 710. Therefore, the AI system 702 can return information via the smart radio devices 712 in a natural language format and/or initiate actions using a machine language format for the machines 714, 718 at the worksite 704.

The unstructured natural language prompt uttered by the worker 710-2 needs particular machine data of a particular machine to resolve the prompt. For example, the utterance “What's the status of the press?” requires particular information about the hydraulic press 714. The machine-generated data can be indicative of a status of the hydraulic press 714 such as an on/off status, an idle status, a paused status, a fault status, and an operational status, which is available in a machine language format. In another example, machine data can include data indicative of a condition or state of a worksite or of a workflow including the relevant machine. Such data can include a worksite operation status, a worksite maintenance status, a worksite construction status, a worksite capacity status, a worksite emergency status, a workflow progress/completion status, a workflow delay status, and a workflow error status. The worksite 704 can include a wide variety of machines, in addition to the lathe 718 and hydraulic press 714. Examples of the machines include material handling equipment, construction and earthmoving equipment, manufacturing and production machines, healthcare and medical equipment, agriculture and farming equipment, and other machines used by frontline workers.

The original natural language prompt input into the user GAI Model 706 can be processed to generate a new or modified prompt that is communicated to the machine GAI Model 708. The machine GAI Model 708 generates instructions in a machine language format to obtain the required information from the machine and initiate actions, if needed, to resolve the original natural language prompt. In the given example, the machine GAI Model 708 generates the machine instruction to obtain the status of the hydraulic press 714. The machine instructions that are generated by the machine GAI Model 708 can be based on a technical specification of the hydraulic press 714. For example, the machine GAI Model 708 can be trained on technical specifications of machines at the worksite 704 including the hydraulic press 714 and lathe 718. As such, the machine GAI Model 708 generates machine-specific instructions for each machine based on technical specification information.

The machine GAI Model 708 processes the machine data and relays the preprocessed data to the user GAI Model 706. For instance, the machine GAI Model 708 can preprocess the machine data, embedding it in a prompt that is then input into the user GAI Model 706. This prompt may include metadata or contextual information regarding the worksite, machine, or other relevant data, aiding the user GAI Model 706 in generating a natural language response based on the machine data to address the initial natural language prompt provided by the worker 710-2. The natural language response is then communicated to the smart radio 712-2.

In the given example, in response to the query from the worker 710-2 regarding the status of the hydraulic press 714, the machine GAI Model 708 can obtain machine data from the hydraulic press 714 indicating that the fluid pressure is elevated. The machine GAI Model 708 can preprocess this data based on technical specifications and relay it to the user GAI Model 706. The user GAI Model 706 can generate a natural language response to address the initial inquiry. The natural language response can be returned to the worker 710-2 through a speaker on the smart radio 712-2, on a display of the smart radio 712-2. For instance, the response might state, “Hi Steve, the fluid pressure is high. You should contact technician Bill Jones, who resolved a similar issue previously.” This response not only identifies a problem based on the machine data but also provides worksite-specific information on resolving the issue. Here, the machine GAI Model 708 is trained in part on technical specifications of the hydraulic press 714, as well as worksite and workflow information, to create an intermediary response processed by the user GAI Model 706 to produce a tailored response, which can even be in the preferred language of the worker 710-2. Thus, the user GAI Model 706 can be trained on both user-specific and worksite-specific information.

In some embodiments, an utterance from a worker contains a command (e.g., “turn the press off”). The user GAI Model 706 can process this command and relay the preprocessed command to the machine GAI Model 708. For instance, the preprocessed command can add location information about the worker, contextual data, or other pertinent information necessary for processing the command. Alternatively, the user GAI Model 706 might inform the worker that they lack authorization to turn off the machine and terminate the command. Otherwise, the machine GAI Model 708 can generate a machine command to direct the appropriate machine or machines to execute the action. In the given example, the machine GAI Model 708 would generate a command to switch off the hydraulic press 714. Following the successful execution of the machine command, the machine GAI Model 708 will notify the user GAI Model 706 that the command has been completed. The user GAI Model 706 then generates a natural language response addressing the initial prompt. In the given example, once the hydraulic press 714 is turned off, the machine GAI Model 708 informs the user GAI Model 706, which generates a natural language response such as “The press has been turned off, Steve,” to be delivered to the worker via their smart radio device.

Although FIG. 7 illustrates two GAI Models, the disclosed technology can use additional specially trained GAI Models or even a single complex GAI Model to carry out functions described above. The GAI Models of the AI system 702 can reside at one or more servers that host the IoW platform or are otherwise coupled to the platform. The servers can be located at the worksite 704, external to the worksite 704, or distributed across both on-site and external locations. In some embodiments, the one or more GAI Models are stored in whole or in part on the portable user devices, on the one or more machines of the worksite, and/or on the servers.

In some implementations, the GAI Models of the AI system 702 receive signals from external sources outside of the portable user devices and machinery at a worksite. For example, a frontline worker might inquire about the hydraulic fluid pressure of the hydraulic press 714 at the worksite 704. Depending on the specific data storage methodologies employed by the worksite 704, the GAI Models can access the pressure sensor in real time by reading sensor data directly from the hydraulic press 714, accessing the pressure sensor through a monitoring device coupled to the hydraulic press 714, or retrieving the most recent sensor data record stored in a database. Consequently, the GAI Models are specifically trained to interface with users or machines at a worksite and interpret both human-readable information and machine data, and look for sources of data outside of their datasets on which they were trained. That is, they can obtain the necessary information to address a prompt even if the data is absent from the GAI Model's dataset, despite different information sources utilizing or interpreting various types of data in distinct formats.

In some embodiments, the GAI Models of the AI system 702 utilize location information when processing prompts. For instance, the GAI Models can receive real-time location data from a portable user device to address a prompt. As an example, if the worker 710-2 is next to the hydraulic press 714 and inquires about the status of “the press,” the user GAI Model 706 can request the location of the worker 710-2 from the smart radio 712-2 to identify the hydraulic press 714 as “the press” situated near the worker. If the worksite 704 contains multiple hydraulic presses, the location data can thus help disambiguate which specific hydraulic press is situated nearest the worker 710-2.

In some embodiments, the GAI Models of the AI system 702 use data associated with the frontline workers to resolve prompts. Such data can be stored at a server or on the portable user device itself. Data associated with the frontline worker can include permissions data, user preferences data, a job role, a job type, and other user-specific information that can be stored as a profile for the worker. In one example, the worker 710-2 is not authorized by their employer to turn off any machinery. As such, in response to a command to “turn off the press,” the GAI Models will not turn off the hydraulic press 714 and, instead, will terminate the request by issuing a notification to the worker 710-2 that they are not authorized to turn off the machine.

In some embodiments, the GAI Models of the AI system 702 are specifically trained for application at the worksite 704. For instance, the machine GAI Model 708 can be trained using data from the specific machines at the worksite 704 and/or data of the smart radio devices utilized by workers at the worksite 704. As an example, if all workers at the worksite 704 refer to a hydraulic press 714 as “Bessy,” the user GAI Model 706 can be trained to interpret “Bessy” as referring to the hydraulic press 714. Additionally, the GAI Models can be tailored for individual workers. For example, the user GAI Model 706 could be trained on data generated by the smart radio 712-2 of the worker 710-2. Moreover, the user GAI Model 706 and the machine GAI Model 708 can be trained using data from multiple or all workers and/or machines of the worksite 704.

In some embodiments, the one or more machines can prompt the one or more GAI Models. That is, the GAI Models can detect a machine-generated prompt that originated at a machine. For example, if the hydraulic press 714 recognizes that its hydraulic fluid pressure is too high, the hydraulic press 714 can generate a machine-generated prompt to request that a worker at the worksite 704 respond to the issue. The GAI Models generate a natural language message indicative of the machine-generated prompt and communicate the natural language message to a worker through a portable user device. In some embodiments, the disclosed technology uses the location data from the portable user devices to determine which worker to send the natural language message to. For example, the disclosed technology can choose to send a message about the fluid pressure of the hydraulic press 714 to the worker 710-1 if the worker 710-1 is the nearest worker to the hydraulic press 714. In some embodiments, the disclosed technology uses user-specific data of the workers to determine which worker to send the natural language message to. For example, the worker 710-2 of the worksite 704 can have a maintenance role while the worker 710-1 can have a machine operator role. The system can use the user-specific role information to select the worker 710-1 to receive the natural language message.

In some embodiments, a frontline worker can respond to the natural language message indicative of the machine-generated prompt through a portable user device (e.g., a smart radio). The frontline worker's response can include natural language, text, and physical gestures. In some embodiments, based on the frontline worker response, the one or more GAI Models generate a machine-specific response that is input into the relevant machine that resolves the machine-generated prompt. In one example, the hydraulic press 714 requests to be turned off due to high fluid pressure. The GAI Models can process this request and communicate it through the smart radio 712-2 to the worker 710-2 (e.g., “The fluid pressure of the hydraulic press is too high, please turn off the hydraulic press”). Then, the worker 710-2 can respond with an utterance including a command input into the smart radio 712-2 to turn the hydraulic press off (e.g., “Turn off the press”). The GAI Models can process this command and generate a machine command that causes the hydraulic press 714 to turn off.

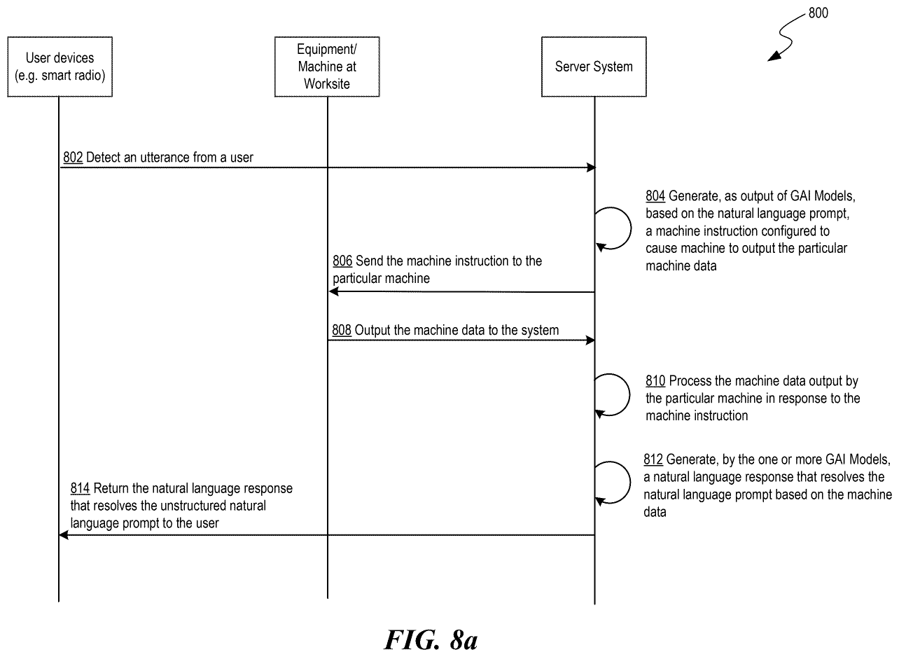

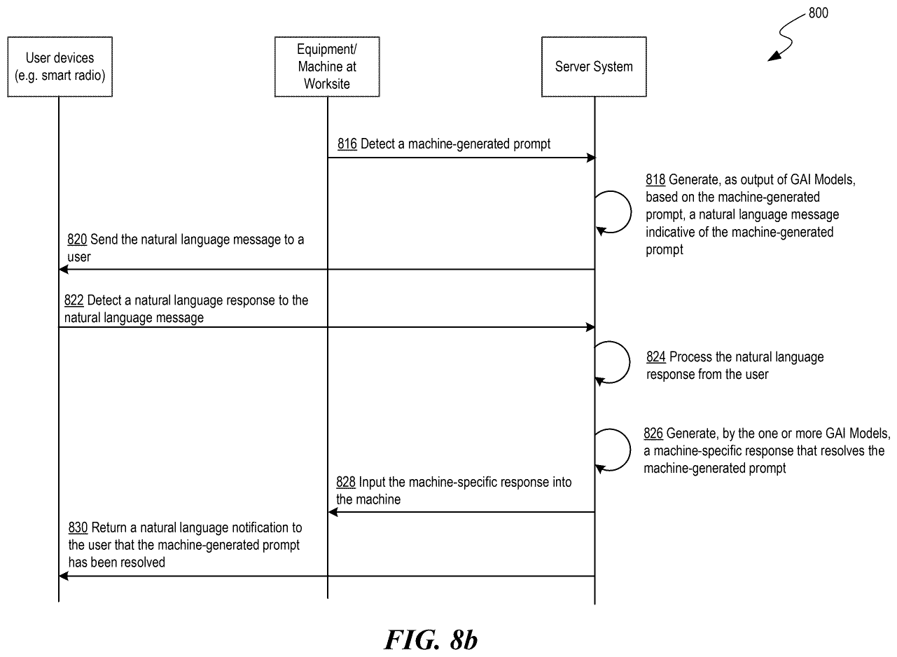

FIG. 8a is a flow diagram of processes performed by a system 800 to exchange communications between frontline workers and machines at a worksite based on a user-generated prompt. The system includes one or more servers that host the IoW platform, user devices such as smart radio devices hosted by the IoW platform, and equipment or machines located at a worksite.

At 802, the system detects an utterance that includes an unstructured natural language prompt input into a smart radio device. For example, particular machine data of a particular machine could be required to resolve the unstructured natural language prompt. The smart radio device is one of multiple smart radio devices hosted by a server for managing communications of workers at a worksite. Further, the worksite includes multiple machines that are each configured to output machine data indicative of a condition or state of the machine, the worksite, or a workflow including the machine.

In one example, the utterance includes an indication of an action to be performed by one or more machines. As such, the one or more GAI Models generate a machine command configured to cause the one or more machines to perform the action. The machine command can be customized based on specifications for each of the one or more machines. The server system that hosts the multiple smart radio devices sends the machine command to the one or more machines. In another example, prior to receiving the utterance, the system detects an actuation of a push-to-talk (PTT) button on the smart radio device. After the actuation of said PTT button, the smart radio device is enabled to detect the utterance.

At 804, the system generates, as an output of one or more GAI Models, based on the unstructured natural language prompt, a machine instruction configured to cause the particular machine to output the particular machine data. In some embodiments, the one or more GAI Models are stored, at least in part, at one or more of the server, the multiple smart radio devices, and the multiple machines. In some embodiments, the one or more GAI Models are trained based on machine data of the multiple machines at the worksite, data generated at the worksite by workers using the multiple smart radio devices, or both. In other embodiments, the one or more GAI Models are trained based on data generated by a particular worker using the multiple smart radio devices at the worksite. Such a particular worker can be associated with any of the multiple smart radio devices, but can only be associated with one at a time.

In one example, the one or more GAI Models include a machine GAI Model and a user GAI Model. The user GAI Model processes the unstructured natural language prompt and is communicatively coupled to the machine GAI Model. The machine GAI Model generates a machine instruction configured to cause the particular machine to output the particular machine data based on the unstructured natural language prompt processed by the user GAI Model.

At 806, the system sends the machine instruction generated at 804 to the particular machine. At 808, the particular machine sends the machine data, retrieved in response to the machine instruction, to the system. In some embodiments, the machine data output by the particular machine is data indicative of a condition or state of the particular machine, the worksite, or a workflow including the particular machine. A condition or state of the particular machine can include any of an on/off status, an idle status, a paused status, a fault status, and an operational status. A condition or state of the worksite can include any of an operational status, a maintenance status, a construction status, an at-capacity status, and an emergency status. A condition or state of the workflow including the machine can include any of a completion status, an in-progress status, a delayed status, and an error status.

At 810, the system processes, by the one or more GAI Models, the machine data output by the particular machine in response to the machine instruction. In an example where the one or more GAI Models include a machine GAI Model and a user GAI Model, the machine GAI Model processes the machine data output by the particular machine in response to the machine instruction.

At 812, the system generates, by the one or more GAI Models, a natural language response that resolves the unstructured natural language prompt based on the machine data. Such a natural language response can include an indication of the machine data in a natural language format. In some embodiments, the system can recognize a user as a source of the utterance received at the smart radio device. Then, the system can determine whether the user is associated with the smart radio device and obtain a permission of the user, which can include data access rights. Finally, the natural language response can be generated by the one or more GAI Models with information precluded based on the data access rights.

In an example where the one or more GAI Models include a machine GAI Model and a user GAI Model, the user GAI Model can generate a natural language response that resolves the unstructured natural language prompt based on the machine data output by the particular machine in response to the machine instruction processed by the machine GAI Model.

At 814, the system causes the smart radio device to return the natural language response that resolves the unstructured natural language prompt. In one example, the prompt includes a command for the machine. In such an example, the system can cause the smart radio device to generate a notification that the command was performed by the one or more machines. In another example, the system can determine that the smart radio device is within a particular area of the worksite. In response to determining that the smart radio device is within the particular area of the worksite, the system can cause a speaker of the smart radio device to render an audible message including the natural language response.

FIG. 8b is a flow diagram of processes performed by the system 800 to exchange communications between frontline workers and machines at a worksite based on a machine-generated prompt. At 816, the system detects a machine-generated prompt from a machine that requires input from a user to resolve. At 818, the system generates, as an output of the one or more GAI Models, based on the machine-generated prompt, a natural language message indicative of the machine-generated prompt. At 820, the system sends the natural language message to the user through a smart radio device of the user. At 822, the system detects a natural language response to the natural language message input by the user into the smart radio device of the user. At 824, the one or more GAI Models process the user input to the smart radio device in response to the machine-generated prompt. At 826, the one or more GAI Models generate a machine-specific response that resolves the machine-generated prompt. At 828, the system inputs the machine-specific response into the machine. At 830, the system returns a natural language notification to the user through the smart radio device of the user that the machine-generated prompt has been resolved.

### Transformer for Neural Network

To assist in understanding the present disclosure, some concepts relevant to neural networks and machine learning (ML) are discussed herein. Generally, a neural network comprises a number of computation units (sometimes referred to as “neurons”). Each neuron receives an input value and applies a function to the input to generate an output value. The function typically includes a parameter (also referred to as a “weight”) whose value is learned through the process of training. A plurality of neurons may be organized into a neural network layer (or simply “layer”) and there may be multiple such layers in a neural network. The output of one layer may be provided as input to a subsequent layer. Thus, input to a neural network may be processed through a succession of layers until an output of the neural network is generated by a final layer. This is a simplistic discussion of neural networks and there may be more complex neural network designs that include feedback connections, skip connections, and/or other such possible connections between neurons and/or layers, which are not discussed in detail here.

A deep neural network (DNN) is a type of neural network having multiple layers and/or a large number of neurons. The term DNN can encompass any neural network having multiple layers, including convolutional neural networks (CNNs), recurrent neural networks (RNNs), multilayer perceptrons (MLPs), Generative Adversarial Networks (GANs), Variational Autoencoders (VAEs), and Auto-regressive Models, among others.

DNNs are often used as ML-based models for modeling complex behaviors (e.g., human language, image recognition, object classification) in order to improve the accuracy of outputs (e.g., more accurate predictions) such as, for example, as compared with models with fewer layers. In the present disclosure, the term “ML-based model” or more simply “ML model” may be understood to refer to a DNN. Training an ML model refers to a process of learning t(he values of the parameters (or weights) of the neurons in the layers such that the ML model is able to model the target behavior to a desired degree of accuracy. Training typically requires the use of a training dataset, which is a set of data that is relevant to the target behavior of the ML model.

As an example, to train an ML model that is intended to model human language (also referred to as a “language model”), the training dataset may be a collection of text documents, referred to as a “text corpus” (or simply referred to as a “corpus”). The corpus may represent a language domain (e.g., a single language), a subject domain (e.g., scientific papers), and/or may encompass another domain or domains, be they larger or smaller than a single language or subject domain. For example, a relatively large, multilingual, and non-subject-specific corpus can be created by extracting text from online webpages and/or publicly available social media posts. Training data can be annotated with ground truth labels (e.g., each data entry in the training dataset can be paired with a label) or may be unlabeled.

Training an ML model generally involves inputting into an ML model (e.g., an untrained ML model) training data to be processed by the ML model, processing the training data using the ML model, collecting the output generated by the ML model (e.g., based on the inputted training data), and comparing the output to a desired set of target values. If the training data is labeled, the desired target values may be, e.g., the ground truth labels of the training data. If the training data is unlabeled, the desired target value may be a reconstructed (or otherwise processed) version of the corresponding ML model input (e.g., in the case of an autoencoder), or can be a measure of some target observable effect on the environment (e.g., in the case of a reinforcement learning agent). The parameters of the ML model are updated based on a difference between the generated output value and the desired target value. For example, if the value outputted by the ML model is excessively high, the parameters may be adjusted so as to lower the output value in future training iterations. An objective function is a way to quantitatively represent how close the output value is to the target value. An objective function represents a quantity (or one or more quantities) to be optimized (e.g., minimize a loss or maximize a reward) in order to bring the output value as close to the target value as possible. The goal of training the ML model typically is to minimize a loss function or maximize a reward function.

The training data can be a subset of a larger data set. For example, a data set may be split into three mutually exclusive subsets: a training set, a validation (or cross-validation) set, and a testing set. The three subsets of data may be used sequentially during ML model training. For example, the training set may be first used to train one or more ML models, each ML model, e.g., having a particular architecture, having a particular training procedure, being describable by a set of model hyperparameters, and/or otherwise being varied from the other of the one or more ML models. The validation (or cross-validation) set may then be used as input data into the trained ML models to, e.g., measure the performance of the trained ML models and/or compare performance between them. Where hyperparameters are used, a new set of hyperparameters can be determined based on the measured performance of one or more of the trained ML models, and the first step of training (e.g., with the training set) may begin again on a different ML model described by the new set of determined hyperparameters. In this way, these steps can be repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) may begin. The output generated from the testing set may be compared with the corresponding desired target values to give a final assessment of the trained ML model's accuracy. Other segmentations of the larger data set and/or schemes for using the segments for training one or more ML models are possible.

Backpropagation is an algorithm for training an ML model. Backpropagation is used to adjust (e.g., update) the value of the parameters in the ML model, with the goal of optimizing the objective function. For example, a defined loss function is calculated by forward propagation of an input to obtain an output of the ML model and a comparison of the output value with the target value. Backpropagation calculates a gradient of the loss function with respect to the parameters of the ML model, and a gradient algorithm (e.g., gradient descent) is used to update (e.g., “learn”) the parameters to reduce the loss function. Backpropagation is performed iteratively so that the loss function is converged or minimized. Other techniques for learning the parameters of the ML model can be used. The process of updating (or learning) the parameters over many iterations is referred to as training. Training may be carried out iteratively until a convergence condition is met (e.g., a predefined maximum number of iterations has been performed, or the value outputted by the ML model is sufficiently converged with the desired target value), after which the ML model is considered to be sufficiently trained. The values of the learned parameters can then be fixed and the ML model may be deployed to generate output in real-world applications (also referred to as “inference”).

In some examples, a trained ML model may be fine-tuned, meaning that the values of the learned parameters may be adjusted slightly in order for the ML model to better model a specific task. Fine-tuning of an ML model typically involves further training the ML model on a number of data samples (which may be smaller in number/cardinality than those used to train the model initially) that closely target the specific task. For example, an ML model for generating natural language that has been trained generically on publicly available text corpora may be, e.g., fine-tuned by further training using specific training samples. The specific training samples can be used to generate language in a certain style or in a certain format. For example, the ML model can be trained to generate a blog post having a particular style and structure with a given topic.

Some concepts in ML-based language models are now discussed. It may be noted that, while the term “language model” has been commonly used to refer to an ML-based language model, there could exist non-ML language models. In the present disclosure, the term “language model” can refer to an ML-based language model (e.g., a language model that is implemented using a neural network or other ML architecture), unless stated otherwise. For example, unless stated otherwise, the “language model” encompasses large language models (LLMs).

A language model can use a neural network (typically a DNN) to perform natural language processing (NLP) tasks. A language model can be trained to model how words relate to each other in a textual sequence, based on probabilities. A language model may contain hundreds of thousands of learned parameters or, in the case of an LLM, can contain millions or billions of learned parameters or more. As non-limiting examples, a language model can generate text, translate text, summarize text, answer questions, write code (e.g., Python, JavaScript, or other programming languages), classify text (e.g., to identify spam emails), create content for various purposes (e.g., social media content, factual content, or marketing content), or create personalized content for a particular individual or group of individuals. Language models can also be used for chatbots (e.g., virtual assistance).

A type of neural network architecture, referred to as a “transformer,” can be used for language models. For example, the Bidirectional Encoder Representations from Transformers (BERT) model, the Transformer-XL model, and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure may be applicable to any ML-based language model, including language models based on other neural network architectures such as recurrent neural network (RNN)-based language models.

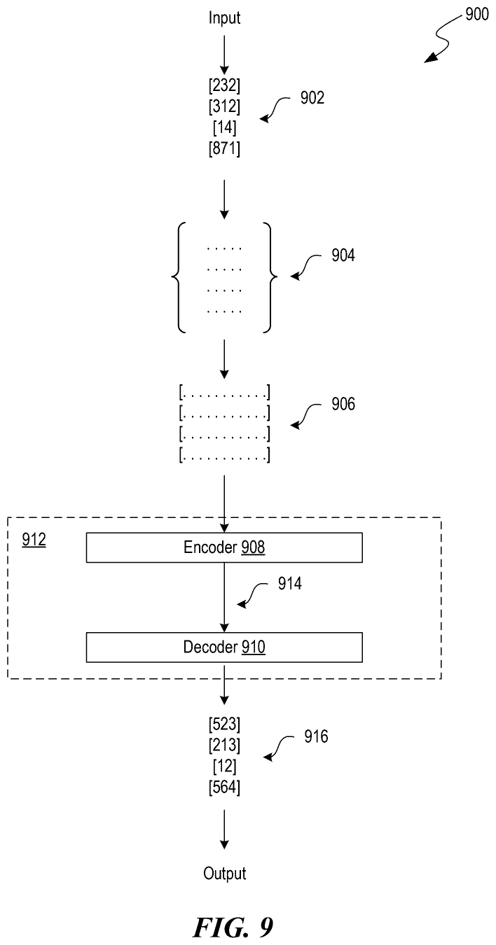

FIG. 9 is a block diagram of an example transformer 912. A transformer is a type of neural network architecture that uses self-attention mechanisms to generate predicted output based on input data that has some sequential meaning (e.g., the order of the input data is meaningful, which is the case for most text input). Self-attention is a mechanism that relates different positions of a single sequence to compute a representation of the same sequence. Although transformer-based language models are described herein, the present disclosure may be applicable to any ML-based language model, including language models based on other neural network architectures such as recurrent neural network (RNN)-based language models.

The transformer 912 includes an encoder 908 (which can include one or more encoder layers/blocks connected in series) and a decoder 910 (which can include one or more decoder layers/blocks connected in series). Generally, the encoder 908 and the decoder 910 each include multiple neural network layers, at least one of which can be a self-attention layer. The parameters of the neural network layers can be referred to as the parameters of the language model.

The transformer 912 can be trained to perform certain functions on a natural language input. Examples of the functions include summarizing existing content, brainstorming ideas, writing a rough draft, fixing spelling and grammar, and translating content. Summarizing can include extracting key points or themes from an existing content in a high-level summary. Brainstorming ideas can include generating a list of ideas based on provided input. For example, the ML model can generate a list of names for a startup or costumes for an upcoming party. Writing a rough draft can include generating writing in a particular style that could be useful as a starting point for the user's writing. The style can be identified as, e.g., an email, a blog post, a social media post, or a poem. Fixing spelling and grammar can include correcting errors in an existing input text. Translating can include converting an existing input text into a variety of different languages. In some implementations, the transformer 912 is trained to perform certain functions on other input formats than natural language input. For example, the input can include objects, images, audio content, or video content, or a combination thereof.

The transformer 912 can be trained on a text corpus that is labeled (e.g., annotated to indicate verbs, nouns) or unlabeled. LLMs can be trained on a large unlabeled corpus. The term “language model,” as used herein, can include an ML-based language model (e.g., a language model that is implemented using a neural network or other ML architecture), unless stated otherwise. Some LLMs can be trained on a large multi-language, multi-domain corpus to enable the model to be versatile at a variety of language-based tasks such as generative tasks (e.g., generating human-like natural language responses to natural language input).

FIG. 9 illustrates an example of how the transformer 912 can process textual input data. Input to a language model (whether transformer-based or otherwise) typically is in the form of natural language that can be parsed into tokens. The term “token” in the context of language models and NLP has a different meaning from the use of the same term in other contexts such as data security. Tokenization, in the context of language models and NLP, refers to the process of parsing textual input (e.g., a character, a word, a phrase, a sentence, a paragraph) into a sequence of shorter segments that are converted to numerical representations referred to as tokens (or “compute tokens”). Typically, a token can be an integer that corresponds to the index of a text segment (e.g., a word) in a vocabulary dataset. Often, the vocabulary dataset is arranged by frequency of use. Commonly occurring text, such as punctuation, can have a lower vocabulary index in the dataset and thus be represented by a token having a smaller integer value than less commonly occurring text. Tokens frequently correspond to words, with or without white space appended. In some implementations, a token can correspond to a portion of a word.

For example, the word “greater” can be represented by a token for [great] and a second token for [er]. In another example, the text sequence “write a summary” can be parsed into the segments [write], [a], and [summary], each of which can be represented by a respective numerical token. In addition to tokens that are parsed from the textual sequence (e.g., tokens that correspond to words and punctuation), there can also be special tokens to encode non-textual information. For example, a [CLASS] token can be a special token that corresponds to a classification of the textual sequence (e.g., can classify the textual sequence as a list, a paragraph), an [EOT] token can be another special token that indicates the end of the textual sequence, other tokens can provide formatting information, etc.

In FIG. 9, a short sequence of tokens 902 corresponding to the input text is illustrated as input to the transformer 912. Tokenization of the text sequence into the tokens 902 can be performed by some pre-processing tokenization module such as, for example, a byte-pair encoding tokenizer (the “pre” referring to the tokenization occurring prior to the processing of the tokenized input by the LLM), which is not shown in FIG. 9 for brevity. In general, the token sequence that is inputted to the transformer 912 can be of any length up to a maximum length defined based on the dimensions of the transformer 912. Each token 902 in the token sequence is converted into an embedding vector 906 (also referred to as “embedding 906”).

An embedding 906 is a learned numerical representation (such as, for example, a vector) of a token that captures some semantic meaning of the text segment represented by the token 902. The embedding 906 represents the text segment corresponding to the token 902 in a way such that embeddings corresponding to semantically related text are closer to each other in a vector space than embeddings corresponding to semantically unrelated text. For example, assuming that the words “write,” “a,” and “summary” each correspond to, respectively, a “write” token, an “a” token, and a “summary” token when tokenized, the embedding 906 corresponding to the “write” token will be closer to another embedding corresponding to the “jot down” token in the vector space as compared to the distance between the embedding 906 corresponding to the “write” token and another embedding corresponding to the “summary” token.

The vector space can be defined by the dimensions and values of the embedding vectors. Various techniques can be used to convert a token 902 to an embedding 906. For example, another trained ML model can be used to convert the token 902 into an embedding 906. In particular, another trained ML model can be used to convert the token 902 into an embedding 906 in a way that encodes additional information into the embedding 906 (e.g., a trained ML model can encode positional information about the position of the token 902 in the text sequence into the embedding 906). In some implementations, the numerical value of the token 902 can be used to look up the corresponding embedding in an embedding matrix 904, which can be learned during training of the transformer 912.

The generated embeddings 906 are input into the encoder 908. The encoder 908 serves to encode the embeddings 906 into feature vectors 914 that represent the latent features of the embeddings 906. The encoder 908 can encode positional information (i.e., information about the sequence of the input) in the feature vectors 914. The feature vectors 914 can have very high dimensionality (e.g., on the order of thousands or tens of thousands), with each element in a feature vector 914 corresponding to a respective feature. The numerical weight of each element in a feature vector 914 represents the importance of the corresponding feature. The space of all possible feature vectors 914 that can be generated by the encoder 908 can be referred to as a latent space or feature space.

Conceptually, the decoder 910 is designed to map the features represented by the feature vectors 914 into meaningful output, which can depend on the task that was assigned to the transformer 912. For example, if the transformer 912 is used for a translation task, the decoder 910 can map the feature vectors 914 into text output in a target language different from the language of the original tokens 902. Generally, in a generative language model, the decoder 910 serves to decode the feature vectors 914 into a sequence of tokens. The decoder 910 can generate output tokens 916 one by one. Each output token 916 can be fed back as input to the decoder 910 in order to generate the next output token 916. By feeding back the generated output and applying self-attention, the decoder 910 can generate a sequence of output tokens 916 that has sequential meaning (e.g., the resulting output text sequence is understandable as a sentence and obeys grammatical rules). The decoder 910 can generate output tokens 916 until a special [EOT] token (indicating the end of the text) is generated. The resulting sequence of output tokens 916 can then be converted to a text sequence in post-processing. For example, each output token 916 can be an integer number that corresponds to a vocabulary index. By looking up the text segment using the vocabulary index, the text segment corresponding to each output token 916 can be retrieved, the text segments can be concatenated together, and the final output text sequence can be obtained.

In some implementations, the input provided to the transformer 912 includes instructions to perform a function on an existing text. The output can include, for example, a modified version of the input text and instructions to modify the text. The modification can include summarizing, translating, correcting grammar or spelling, changing the style of the input text, lengthening or shortening the text, or changing the format of the text (e.g., adding bullet points or checkboxes). As an example, the input text can include meeting notes prepared by a user and the output can include a high-level summary of the meeting notes. In other examples, the input provided to the transformer includes a question or a request to generate text. The output can include a response to the question, text associated with the request, or a list of ideas associated with the request. For example, the input can include the question “What is the weather like in San Francisco?” and the output can include a description of the weather in San Francisco. As another example, the input can include a request to brainstorm names for a flower shop and the output can include a list of relevant names.

Although a general transformer architecture for a language model and its theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that can be considered to be an encoder-only language model. A decoder-only language model accepts embeddings as input and can use auto-regression to generate an output text sequence. Transformer-XL and GPT-type models can be language models that are considered to be decoder-only language models.

Because GPT-type language models tend to have a large number of parameters, these language models can be considered LLMs. An example of a GPT-type LLM is GPT-3. GPT-3 is a type of GPT language model that has been trained (in an unsupervised manner) on a large corpus derived from documents available online to the public. GPT-3 has a very large number of learned parameters (on the order of hundreds of billions), can accept a large number of tokens as input (e.g., up to 2,048 input tokens), and is able to generate a large number of tokens as output (e.g., up to 2,048 tokens). GPT-3 has been trained as a generative model, meaning that it can process input text sequences to predictively generate a meaningful output text sequence. ChatGPT is built on top of a GPT-type LLM and has been fine-tuned with training datasets based on text-based chats (e.g., chatbot conversations). ChatGPT is designed for processing natural language, receiving chat-like inputs, and generating chat-like outputs.

A computer system can access a remote language model (e.g., a cloud-based language model), such as ChatGPT or GPT-3, via a software interface (e.g., an API). Additionally or alternatively, such a remote language model can be accessed via a network such as the Internet. In some implementations, such as, for example, potentially in the case of a cloud-based language model, a remote language model can be hosted by a computer system that can include a plurality of cooperating (e.g., cooperating via a network) computer systems that can be in, for example, a distributed arrangement. Notably, a remote language model can employ multiple processors (e.g., hardware processors such as, for example, processors of cooperating computer systems). Indeed, processing of inputs by an LLM can be computationally expensive/can involve a large number of operations (e.g., many instructions can be executed/large data structures can be accessed from memory), and providing output in a required timeframe (e.g., real time or near real time) can require the use of a plurality of processors/cooperating computing devices as discussed above.

Inputs to an LLM can be referred to as a prompt, which is a natural language input that includes instructions to the LLM to generate a desired output. A computer system can generate a prompt that is provided as input to the LLM via an API (e.g., the API 128 in FIG. 1). As described above, the prompt can optionally be processed or pre-processed into a token sequence prior to being provided as input to the LLM via its API. A prompt can include one or more examples of the desired output, which provides the LLM with additional information to enable the LLM to generate output according to the desired output. Additionally or alternatively, the examples included in a prompt can provide inputs (e.g., example inputs) corresponding to/as can be expected to result in the desired outputs provided. A one-shot prompt refers to a prompt that includes one example, and a few-shot prompt refers to a prompt that includes multiple examples. A prompt that includes no examples can be referred to as a zero-shot prompt.

### Computing System

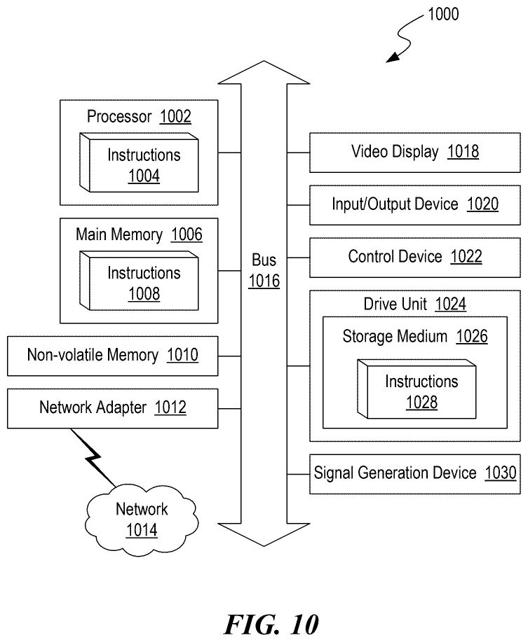

FIG. 10 is a block diagram illustrating an example computer system 1000, in accordance with one or more embodiments. At least some operations described herein are implemented on the computer system 1000. The computer system 1000 includes one or more central processing units (“processors”) 1002, main memory 1006, non-volatile memory 1010, network adapters 1012 (e.g., network interface), video displays 1018, input/output devices 1020, control devices 1022 (e.g., keyboard and pointing devices), drive units 1024 including a storage medium 1026, and a signal generation device 1030 that are communicatively connected to a bus 1016. The bus 1016 is illustrated as an abstraction that represents one or more physical buses and/or point-to-point connections that are connected by appropriate bridges, adapters, or controllers. In embodiments, the bus 1016 includes a system bus, a Peripheral Component Interconnect (PCI) bus or PCI-Express bus, a HyperTransport or industry standard architecture (ISA) bus, a small computer system interface (SCSI) bus, a universal serial bus (USB), an IIC (I2C) bus, or an IEEE standard 1394 bus (also referred to as “Firewire”).

In embodiments, the computer system 1000 shares a similar computer processor architecture as that of a desktop computer, tablet computer, personal digital assistant (PDA), mobile phone, game console, music player, wearable electronic device (e.g., a watch or fitness tracker), network-connected (“smart”) device (e.g., a television or home assistant device), virtual/augmented reality systems (e.g., a head-mounted display), or another electronic device capable of executing a set of instructions (sequential or otherwise) that specify action(s) to be taken by the computer system 1000.

While the main memory 1006, non-volatile memory 1010, and storage medium 1026 (also called a “machine-readable medium”) are shown to be a single medium, the terms “machine-readable medium” and “storage medium” should be taken to include a single medium or multiple media (e.g., a centralized/distributed database and/or associated caches and servers) that store one or more sets of instructions 1028. The terms “machine-readable medium” and “storage medium” shall also be taken to include any medium that is capable of storing, encoding, or carrying a set of instructions for execution by the computer system 1000.

In general, the routines executed to implement the embodiments of the disclosure are implemented as part of an operating system or a specific application, component, program, object, module, or sequence of instructions (collectively referred to as “computer programs”). The computer programs typically include one or more instructions (e.g., instructions 1004, 1008, 1028) set at various times in various memory and storage devices in a computer device. When read and executed by the one or more processors 1002, the instruction(s) cause the computer system 1000 to perform operations to execute elements involving the various aspects of the disclosure.

Moreover, while embodiments have been described in the context of fully functioning computer devices, those skilled in the art will appreciate that the various embodiments are capable of being distributed as a program product in a variety of forms. The disclosure applies regardless of the particular type of machine or computer-readable media used to actually effect the distribution.

Further examples of machine-readable storage media, machine-readable media, or computer-readable media include recordable-type media such as volatile and non-volatile memory devices 1010, floppy and other removable disks, hard disk drives, optical discs (e.g., Compact Disc Read-Only Memory (CD-ROMS), Digital Versatile Discs (DVDs)), and transmission-type media such as digital and analog communication links.

The network adapter 1012 enables the computer system 1000 to mediate data in a network 1014 with an entity that is external to the computer system 1000 through any communication protocol supported by the computer system 1000 and the external entity. In embodiments, the network adapter 1012 includes a network adapter card, a wireless network interface card, a router, an access point, a wireless router, a switch, a multilayer switch, a protocol converter, a gateway, a bridge, a bridge router, a hub, a digital media receiver, and/or a repeater.

In embodiments, the network adapter 1012 includes a firewall that governs and/or manages permission to access proxy data in a computer network and tracks varying levels of trust between different machines and/or applications. In embodiments, the firewall is any number of modules having any combination of hardware and/or software components able to enforce a predetermined set of access rights between a particular set of machines and applications, machines and machines, and/or applications and applications (e.g., to regulate the flow of traffic and resource sharing between these entities). The firewall additionally manages and/or has access to an access control list that details permissions including the access and operation rights of an object by an individual, a machine, and/or an application, and the circumstances under which the permission rights stand.

In embodiments, the functions performed in the processes and methods are implemented in differing order. Furthermore, the outlined steps and operations are only provided as examples. For example, some of the steps and operations are optional, combined into fewer steps and operations, or expanded into additional steps and operations without detracting from the essence of the disclosed embodiments.

In embodiments, the techniques introduced here are implemented by programmable circuitry (e.g., one or more microprocessors), software and/or firmware, special-purpose hardwired (i.e., non-programmable) circuitry, or a combination of such forms. In embodiments, special-purpose circuitry is in the form of one or more application-specific integrated circuits (ASICs), programmable logic devices (PLDs), field-programmable gate arrays (FPGAs), etc.

The description and drawings herein are illustrative and are not to be construed as limiting. Numerous specific details are described to provide a thorough understanding of the disclosure. However, in certain instances, well-known details are not described in order to avoid obscuring the description. Further, various modifications can be made without deviating from the scope of the embodiments.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. It will be appreciated that the same thing can be said in more than one way. One will recognize that “memory” is one form of a “storage” and that the terms are on occasion used interchangeably.

Consequently, alternative language and synonyms are used for any one or more of the terms discussed herein, and no special significance is to be placed upon whether or not a term is elaborated or discussed herein. Synonyms for certain terms are provided. A recital of one or more synonyms does not exclude the use of other synonyms. The use of examples anywhere in this specification, including examples of any term discussed herein, is illustrative only and is not intended to further limit the scope and meaning of the disclosure or of any exemplified term. Likewise, the disclosure is not limited to various embodiments given in this specification.

1. A method comprising:
detecting an utterance that includes an unstructured natural language prompt input into a smart radio device,
wherein particular machine data of a particular machine are required to resolve the unstructured natural language prompt,
wherein the smart radio device is one of multiple smart radio devices hosted by a server for managing communications of workers at a worksite, and
wherein the worksite includes multiple machines that are each configured to output machine data indicative of a condition or state of the machine, the worksite, or a workflow including the machine;
generating, as an output of one or more generative artificial intelligence models (“GAI Models”), based on the unstructured natural language prompt, a machine instruction configured to cause the particular machine to output the particular machine data;
processing, by the one or more GAI Models, the machine data output by the particular machine in response to the machine instruction;
generating, by the one or more GAI Models, a natural language response that resolves the unstructured natural language prompt based on the machine data,
wherein the natural language response presents at least an indication of the machine data in a natural language format; and
causing the smart radio device to return the natural language response that resolves the unstructured natural language prompt.

2. The method of claim 1, wherein the utterance includes an indication of an action to be performed by one or more machines, the method further comprising:
generating, by the one or more GAI Models, a machine command configured to cause the one or more machines to perform the action,
wherein the machine command is customized based on specifications for each of the one or more machines;
sending, via the server that hosts the multiple smart radio devices, the machine command to the one or more machines; and
causing the smart radio device to generate a notification that the action was performed by the one or more machines.

3. The method of claim 1, further comprising:
determining that a location of the smart radio device is within a particular area of the worksite; and
in response to determining that the smart radio device is within the particular area of the worksite, causing a speaker of the smart radio device to render an audible message including the natural language response.

4. The method of claim 1, further comprising:
recognizing a user as a source of the utterance received at the smart radio device;
determining that the user is associated with the smart radio device,
wherein the user can be associated with any of the multiple smart radio devices, only one at a time; and
obtaining a permission of the user including data access rights,
wherein the natural language response is generated by the one or more GAI Models to preclude information based on the data access rights.

5. The method of claim 1, further comprising:
training the one or more GAI Models based on machine data of the multiple machines at the worksite, data generated at the worksite by workers using the multiple smart radio devices, or both.

6. The method of claim 1, further comprising, prior to receiving the utterance:
detecting actuation of a push-to-talk (PTT) button on the smart radio device,
wherein the smart radio device is enabled to detect the utterance upon the PTT button being pressed at the smart radio device.

7. The method of claim 1, wherein the multiple machines at the worksite include any of:
material handling equipment,
construction and earthmoving equipment,
manufacturing and production machines,
healthcare and medical equipment, or
agriculture and farming equipment.

8. The method of claim 1, further comprising:
detecting a machine-generated prompt generated by a machine,
wherein user input is required to resolve the machine-generated prompt;
generating, as an output of the one or more GAI Models, based on the machine-generated prompt, a natural language message indicative of the machine-generated prompt;
processing, by the one or more GAI Models, the user input to the smart radio device in response to the machine-generated prompt,
wherein the user input is in a natural language format;
generating, by the one or more GAI Models, a machine-specific response that resolves the machine-generated prompt; and
inputting the machine-specific response into the machine.

9. The method of claim 1, further comprising:
storing the one or more GAI Models at least in part at one or more of the server, the multiple smart radio devices, and the multiple machines.

10. The method of claim 1, further comprising:
training the one or more GAI Models based on data generated by a particular worker using the multiple smart radio devices at the worksite,
wherein the particular worker can be associated with any of the multiple smart radio devices, only one at a time.

11. The method of claim 1, further comprising:
causing the particular machine to output machine data indicative of a condition or state of the particular machine, the worksite, or a workflow including the particular machine,
wherein the condition or state of the particular machine includes any of an on/off status, an idle status, a paused status, a fault status, and an operational status,
wherein the condition or state of the worksite includes any of an operational status, a maintenance status, a construction status, an at-capacity status, and an emergency status, and
wherein the condition or state of the workflow including the particular machine can include any of a completed status, an in-progress status, a delayed status, and an error status.

12. The method of claim 1, wherein the one or more GAI Models include a machine GAI Model and a user GAI Model, the method further comprising:
processing, by the user GAI Model, the unstructured natural language prompt,
wherein the user GAI Model is communicatively coupled to the machine GAI Model;
generating, as an output of the machine GAI Model, a machine instruction configured to cause the particular machine to output the particular machine data,
wherein the machine GAI Model generates the machine instruction based on the unstructured natural language prompt processed by the user GAI Model;
processing, by the machine GAI Model, the machine data output by the particular machine in response to the machine instruction; and
generating, by the user GAI Model, a natural language response that resolves the unstructured natural language prompt based on the machine data output by the particular machine in response to the machine instruction processed by the machine GAI Model.

13. A system comprising:
at least one hardware processor; and
at least one non-transitory memory storing instructions, which, when executed by the at least one hardware processor, cause the system to:
detect an utterance that includes an unstructured natural language prompt input into a smart radio device,
wherein particular machine data of a particular machine are required to resolve the unstructured natural language prompt,
wherein the smart radio device is one of multiple smart radio devices hosted by a server for managing communications of workers at a worksite, and
wherein the worksite includes multiple machines that are each configured to output machine data indicative of a condition or state of the machine, the worksite, or a workflow including the machine;
generate, as an output of one or more generative artificial intelligence models (“GAI Models”), based on the unstructured natural language prompt, a machine instruction configured to cause the particular machine to output the particular machine data;
process, by the one or more GAI Models, the machine data output by the particular machine in response to the machine instruction;
generate, by the one or more GAI Models, a natural language response that resolves the unstructured natural language prompt based on the machine data,
wherein the natural language response presents at least an indication of the machine data in a natural language format; and
cause the smart radio device to return the natural language response that resolves the unstructured natural language prompt.

14. The system of claim 13, wherein the utterance includes an indication of an action to be performed by one or more machines, the system being further caused to:
generate, by the one or more GAI Models, a machine command configured to cause the one or more machines to perform the action,
wherein the machine command is customized based on specifications for each of the one or more machines;
send, via a server that hosts the multiple smart radio devices, the machine command to the one or more machines; and
cause the smart radio device to generate a notification that the action was performed by the one or more machines.

15. The system of claim 13, being further caused to:
determine that a location of the smart radio device is within a particular area of the worksite; and
in response to determining that the smart radio device is within the particular area of the worksite, cause a speaker of the smart radio device to render an audible message including the natural language response.

16. The system of claim 13, being further caused to:
detect a machine-generated prompt generated by a machine,
wherein user input is required to resolve the machine-generated prompt;
generate, as an output of the one or more GAI Models, based on the machine-generated prompt, a natural language message indicative of the machine-generated prompt;
process, by the one or more GAI Models, the user input to the smart radio device in response to the machine-generated prompt,
wherein the user input is in a natural language format;
generate, by the one or more GAI Models, a machine-specific response that resolves the machine-generated prompt; and
input the machine-specific response into the machine.

17. A non-transitory, computer-readable storage medium comprising instructions recorded thereon, wherein the instructions, when executed by at least one data processor of a system, cause the system to:
detect an utterance that includes an unstructured natural language prompt input into a smart radio device,
wherein particular machine data of a particular machine are required to resolve the unstructured natural language prompt,
wherein the smart radio device is one of multiple smart radio devices hosted by a server for managing communications of workers at a worksite, and
wherein the worksite includes multiple machines that are each configured to output machine data indicative of a condition or state of the machine, the worksite, or a workflow including the machine;
generate, as an output of one or more generative artificial intelligence models (“GAI Models”), based on the unstructured natural language prompt, a machine instruction configured to cause the particular machine to output the particular machine data;
process, by the one or more GAI Models, the machine data output by the particular machine in response to the machine instruction;
generate, by the one or more GAI Models, a natural language response that resolves the unstructured natural language prompt based on the machine data,
wherein the natural language response presents at least an indication of the machine data in a natural language format; and
cause the smart radio device to return the natural language response that resolves the unstructured natural language prompt.

18. The system of claim 17, wherein the utterance includes an indication of an action to be performed by one or more machines, the system being further caused to:
generate, by the one or more GAI Models, a machine command configured to cause the one or more machines to perform the action,
wherein the machine command is customized based on specifications for each of the one or more machines;
send, via a server that hosts the multiple smart radio devices, the machine command to the one or more machines; and
cause the smart radio device to generate a notification that the action was performed by the one or more machines.

19. The system of claim 17, being further caused to:
determine that a location of the smart radio device is within a particular area of the worksite; and
in response to determining that the smart radio device is within the particular area of the worksite, cause a speaker of the smart radio device to render an audible message including the natural language response.

20. The system of claim 17, being further caused to:
detect a machine-generated prompt generated by a machine,
wherein user input is required to resolve the machine-generated prompt;
generate, as an output of the one or more GAI Models, based on the machine-generated prompt, a natural language message indicative of the machine-generated prompt;
process, by the one or more GAI Models, the user input to the smart radio device in response to the machine-generated prompt,
wherein the user input is in a natural language format;
generate, by the one or more GAI Models, a machine-specific response that resolves the machine-generated prompt; and
input the machine-specific response into the machine.
